(19) United States
(12) Patent Application Publication
(10) Pub. No.: US 2017/0061286 A1
(43) Pub. Date: Mar. 2, 2017

(54) Supervised Learning Based Recommendation System

(71) Applicant: Skytree, Inc., San Jose, CA (US)

(72) Inventors: Nitesh Kumar, Milpitas, CA (US); Arkadas Ozakin, San Jose, CA (US); Alexander Gray, Santa Clara, CA (US); Abhimanyu Aditya, San Jose, CA (US)

(21) Appl. No.: 15/249,386

(22) Filed: Aug. 27, 2016

Related U.S. Application Data
(60) Provisional application No. 62/210,929, filed on Aug. 27, 2015.
(60) Provisional application No. 62/214,806, filed on Sep. 4, 2015.

(51) Int. Cl. G06N 5/02; G06N 99/00

(52) U.S. Cl. CPC G06N 5/02; G06N 99/005

(57) ABSTRACT

A system and method for generating a recommendation system based on supervised learning includes generating a master dataset, selecting a subset of features and a subset of rows in the master dataset, selecting a supervised learning method, building a first model based on a first dataset and the supervised learning method, the first dataset being restricted to the subset of features and the subset of rows in the master dataset, determining a set of candidate items, identifying a first user, generating a prediction of a user response of the first user to the set of candidate items based on the first model, and generating a recommendation of a first candidate item based on the prediction.

### CROSS REFERENCE TO RELATED APPLICATIONS

The present application claims priority, under 35 U.S.C. §119, of U.S. Provisional Patent Application No. 62/210,929, filed Aug. 27, 2015 and entitled “Method for Producing a Recommendation System,” and of U.S. Provisional Patent Application No. 62/214,806, filed Sep. 4, 2015 and entitled “Method for Producing a Recommendation System,” which are incorporated by reference in its entirety.

### BACKGROUND

Recommendation systems are applied in a variety of applications. For example, recommendation systems are used to recommend movies, music, restaurants, books, news, and various other products for user consumption. Recommendation systems typically produce a list of recommendations through collaborative filtering or content-based filtering. Collaborative filtering (CF) builds a model based on a user's past behavior (items previously purchased or selected and/or numerical ratings given to those items) and behavior of other users. Collaborative filtering methods are based on collecting and analyzing a large amount of information on users' behaviors, activities or preferences and predicting what users will like based on the similarities between users or items. The similarities between users and items in the context of CF are measured in terms of the common items liked by users, or the common users that like given items, respectively, instead of, e.g. measuring item similarity in terms of item content. Content-based filtering uses a series of characteristics of an item in order to recommend additional items with similar properties. Content-based filtering methods are based on a description of the item and a profile of the user's preference. In a content-based recommendation system, keywords are used to describe the items, and a user profile is built to indicate the type of item this user likes. In other words, these algorithms try to recommend items that are similar to those that a user liked in the past (or is examining in the present).

However, these prior art approaches have a number of problems and shortcomings. For example, collaborative filtering suffers from a problem referred as a “cold start” problem because a large amount of information on a user is required in order to make accurate recommendation for that user. Collaborative filtering methods also suffer from scalability and sparsity problems. Similarly, content-based filtering suffers from a breadth or scope problem in that it can only make recommendations for content or products for items that have similar attributes to the items that have been classified.

Thus, there is a need for a system and method that generates or creates a recommendation system that can more accurately predict user preferences and at least partially overcome the aforementioned issues of content-based filtering and collaborative filtering.

### SUMMARY

The present disclosure overcomes the deficiencies of the prior art by providing a system and method for generating a recommendation system using supervised learning.

In general, another innovative aspect of the present disclosure described in this disclosure may be embodied in a method for generating a master dataset including user data, item data, and user-item interaction data of a plurality of users, selecting a subset of features and a subset of rows in the master dataset, the subset of rows corresponding to a first set of users sharing a similar attribute in the master dataset, selecting a supervised learning method, building a first model based on a first dataset and the supervised learning method, the first dataset being restricted to the subset of features and the subset of rows in the master dataset, identifying a first user from the first set of users, determining a set of candidate items, generating a prediction of a user response of the first user to the set of candidate items based on the first model, generating a recommendation of a first candidate item based on the prediction, and transmitting the recommendation to a client device for display to the first user.

Other aspects include corresponding methods, systems, apparatus, and computer program products for these and other innovative aspects. These and other implementations may each optionally include one or more of the following features.

For instance, the operations further include retrieving user data of the plurality of users, retrieving item data of a plurality of items, retrieving positive user-item interaction data for the plurality of users and the plurality of items, determining whether negative user-item interaction data for the plurality of users and the plurality of items is retrievable, responsive to determining that the negative user-item interaction data is non-retrievable, artificially creating the negative user-item interaction data, and combining the user data, the item data, the positive user-item interaction data, and the negative user-item interaction data into a plurality of rows in the dataset. For instance, the operations further include identifying a set of active users in the dataset, identifying a set of topmost active items that the set of active users ignored, and artificially creating the negative user-item interaction data based on the set of active users and the set of topmost active items. For instance, the operations further include determining a business rule influencing the recommendation of the first candidate item, and determining the set of candidate items that satisfies a constraint of the business rule. For instance, the operations further include determining whether the first user is a new user, and responsive to determining that the first user is the new user, identifying a number of items for inclusion in the set of candidate items that satisfies the constraint of the business rule, the number of items identified from one or more items most popular with existing users, and items interacted with favorably by a set of one or more users similar to the first user. For instance, the operations further include determining whether the first user is a new user, and responsive to determining that the first user is not the new user, identifying a number of items for inclusion in the set of candidate items that satisfies the constraint of the business rule, the number of items identified from one or more of items most popular with existing users, items similar to those items interacted with favorably by the first user, and items interacted with favorably by a set of one or more other users similar to the first user. For instance, the operations further include determining a business objective, determining a business rule influencing the recommendation of the first candidate item, and identifying a proxy for the business objective, the proxy for the business objective being based on the prediction of the user response, wherein the recommendation of the first candidate item is based on an optimization of the proxy for the business objective and a constraint of the business rule.

For instance, the features further include the similar attribute as including one from a group of usage behavior and demographics. For instance, the features further include the business objective as including one from a group of profit, revenue, user retention, number of user interactions, user interaction time, and user interaction type. For instance, the features further include the user response of the first user to the set of candidate items as including one from a group of like, dislike, purchase, view, ignore, rating, and total interaction time.

The present disclosure is particularly advantageous because it formulates the generation of recommendation as supervised learning. In particular, such formulation allows business goals (e.g., profit) and business rules (e.g., arbitrary business requirement to honor contractual or vested interest) to be directly optimizable by being integrated in a supervised learning model. Another advantage of the approach is its natural ability to incorporate data or features from multiple data sources—items, users, user devices, and such.

The features and advantages described herein are not all-inclusive and many additional features and advantages should be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example of a system for producing a recommendation using supervised learning in accordance with one implementation of the present disclosure.

FIG. 2 is a block diagram illustrating an example of a recommendation server in accordance with one implementation of the present disclosure.

FIGS. 3-5 depict graphical representations of example data diagram of user, item and user-item interaction data respectively, which are collected according to the techniques described herein to be used for creation of a recommendation system in accordance with one implementation of the present disclosure.

FIG. 6 is a flowchart of an example method for creating a recommendation system and using it to determine a recommended item list in accordance with one implementation of the present disclosure.

FIG. 7 is a flowchart of an example method for collecting user data in accordance with one implementation of the present disclosure.

FIG. 8 is a flowchart of an example method for collecting item data in accordance with one implementation of the present disclosure.

FIG. 9 is a flowchart of an example method for collecting user-item interaction data in accordance with one implementation of the present disclosure.

FIG. 10 is a flowchart of an example method for aggregating and organizing user, item and interaction data in accordance with one implementation of the present invention.

FIG. 11 is a flowchart of an example method for building a model for recommending items using supervised learning and providing recommended items to a user.

### DETAILED DESCRIPTION

A system and method for generating a recommendation system using supervised learning is described. In the following description, for purposes of explanation, numerous specific details are set forth in order to provide a thorough understanding of the disclosure. It should be apparent, however, that the disclosure may be practiced without these specific details. In other instances, structures and devices are shown in block diagram form in order to avoid obscuring the disclosure. For example, the present disclosure is described in one implementation below with reference to particular hardware and software implementations. However, the present disclosure applies to other types of implementations distributed in the cloud, over multiple machines, using multiple processors or cores, using virtual machines or integrated as a single machine.

Reference in the specification to “one implementation” or “an implementation” means that a particular feature, structure, or characteristic described in connection with the implementation is included in at least one implementation of the disclosure. The appearances of the phrase “in one implementation” in various places in the specification are not necessarily all referring to the same implementation. In particular the present disclosure is described below in the context of multiple distinct architectures and some of the components are operable in multiple architectures while others are not.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the method and system described herein, such as the logic, may also be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and so on.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems should appear from the description below. In addition, the present disclosure is described without reference to any particular programming language. It should be appreciated that a variety of programming languages may be used to implement the teachings of the disclosure as described herein.

### Example System(s)

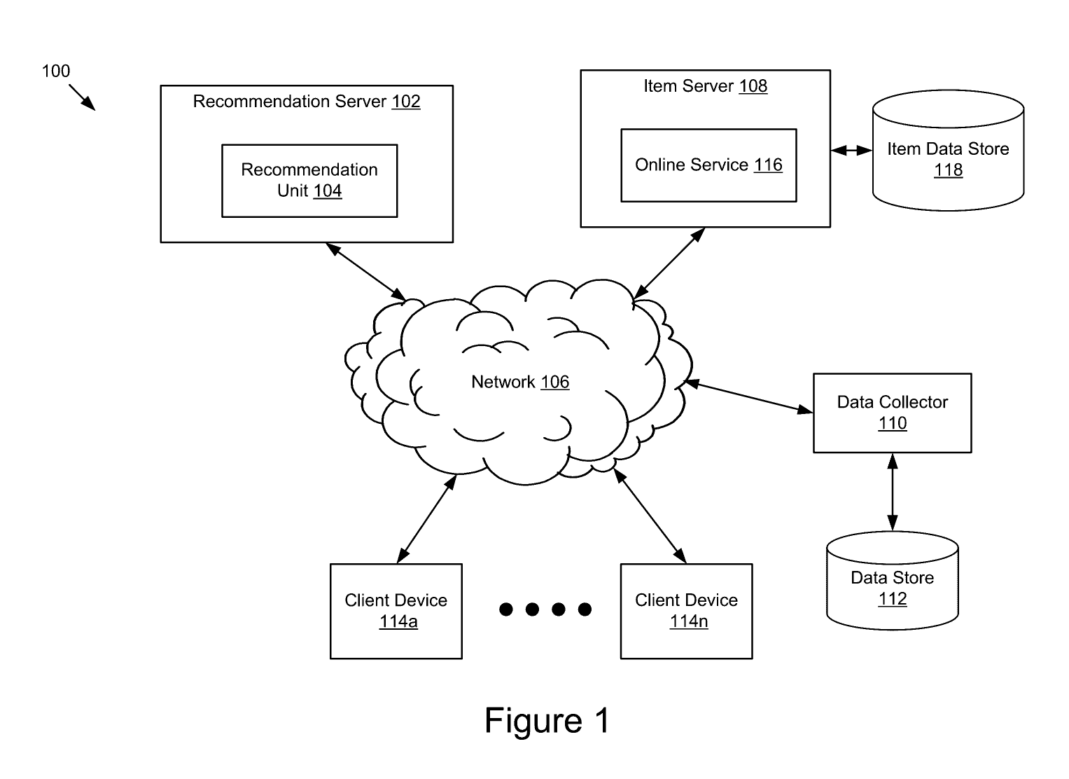

FIG. 1 is a block diagram illustrating an example of a system 100 for producing a recommendation using supervised learning in accordance with one implementation of the present disclosure. Referring to FIG. 1, the illustrated system 100 comprises: a recommendation server 102 including a recommendation unit 104, an item server 108 including an online service 116 and associated item data store 118, a plurality of client devices 114a . . . 114n, and a data collector 110 and associated data store 112. In FIG. 1 and the remaining figures, a letter after a reference number, e.g., “114a,” represents a reference to the element having that particular reference number. A reference number in the text without a following letter, e.g., “114,” represents a general reference to instances of the element bearing that reference number. In the depicted implementation, the recommendation server 102, the item server 108, the plurality of client devices 114a . . . 114n, and the data collector 110 are communicatively coupled via the network 106.

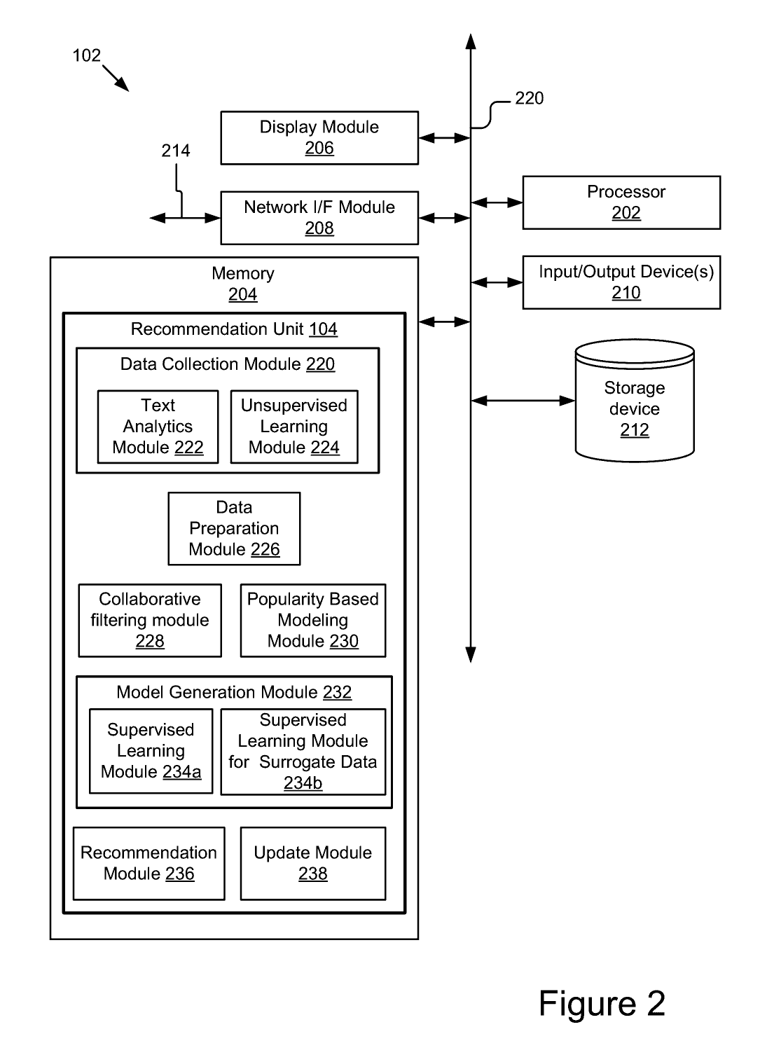

In some implementations, the system 100 includes a recommendation server 102 coupled to the network 106 for communication with the other components of the system 100, such as the plurality of client devices 114a . . . 114n, the item server 108 and associated item data store 118, and the data collector 110 and associated data store 112. In the example of FIG. 1, the component of the recommendation server 102 may be configured to implement the recommendation unit 104 described in detail below with reference to FIG. 2. In some implementations, the recommendation server 102 provides services to a data analysis customer by receiving and processing information from the plurality of resources or devices 108, 110, and 114 to create predictive models and, in some instances, generate recommendations based on those models. In some implementations, the recommendation server 102 provides the predictive model to the item server 108 for use in generating item recommendations for users subscribed to the online service 116 hosted by the item server 108. Although only a single recommendation server 102 is shown in FIG. 1, it should be understood that there may be any number of recommendation servers 102 or a server cluster, which may be load balanced.

In some implementations, the system 100 includes an item server 108 coupled to the network 106 for communication with other components of the system 100, such as the plurality of client devices 114a . . . 114n, the recommendation server 102, and the data collector 110 and associated data store 112. In some implementations, the item server 108 includes an online service 116 dedicated to providing a service hosted by the item server 108. The online service 116 may receive and process content requests from the plurality of client devices 114a . . . 114n. The online service 116 may obtain user data, item data, and user-item interaction data and features for each of the users and/or items and store them in the item data store 118. The user-item interaction data may also be referred to herein simply as “interaction data.” In some implementations, the item server 108 may record information for users who interact with the item server 108 (e.g., via an application or web browser on a client device 114) and store the information in the item data store 118. The item server 108 may provide (e.g., in response to a request, individually or for a group of users) the user data or profile to the recommendation unit 104 or another service, such as the data collector 110.

The item data store 118 is coupled to the item server 108. The item data store 118 may be a non-volatile memory device or similar permanent storage device and media. The item data store 118 stores data including content items (e.g., videos) for the item server 108 and may be used to store information collected by the online service 116 hosted by the item server 108 or client devices 114. For example, the item data store 118 stores (e.g., as recorded by the online service 116) user data for users, item data for items (e.g., videos), and interaction data reflecting the interactions of users with the items. User data, as described herein, may include one or more of user profile information (e.g., user id, purchase history, income, education, etc.), logged information (e.g., clickstream, IP addresses, user device specific information, historical actions, etc.), and other user specific information.

In some implementations, the online service 116 hosted by the item server 108 may communicate with the recommendation server 102 to provide recommendations to users subscribed to the online service 116. The online service 116 may incorporate the components of or send requests (which may include user, item, or interaction data collected by the online service 116) to the recommendation server 102 to create models and/or recommendations for users and items.

In one example, the online service 116 hosted by the item server 108 may be a video sharing online service. For example, the video sharing online service may be associated with one or more television or cable channels, networks, or online video service providers, such as Hulu™, YouTube™, Vimeo™, NBC™, ABC™, ESPN™, Amazon™, Netflix™, etc. In some implementations, the video sharing online service allows users to upload and/or share videos with other users (e.g., friends, contacts, the public, similar users, etc.). In some implementations, the video sharing online service allows users to purchase, rent, watch later, create playlist, or subscribe to videos. The video sharing online service may communicate with the recommendation server 102 to provide recommendations to a user regarding videos to view, purchase, share, etc. For example, the video sharing online service may transmit user, item, or interaction data collected by the video sharing online service to the recommendation server 102 and receive a recommendation system, models, and/or recommendations from the recommendation server 102.

In another example, the online service 116 hosted by the item server 108 may be an audio sharing online service. For example, the audio sharing online service may be associated with a channel, network, or online audio provider, such as Spotify®, Pandora®, SoundCloud®, etc. In some implementations, the audio sharing online service allows users to upload and/or share audio clips or podcasts with other users (e.g., subscribers, friends, contacts, the public, similar users, etc.). In some implementations, the audio sharing online service allows users to purchase, rent, or subscribe to audio. The audio sharing online service may record user, item, and interaction information and communicate with the recommendation server 102 to provide recommendations to a user regarding audio to listen to, purchase, share, etc.

In another example, the online service 116 hosted by the item server 108 may be an e-commerce website. For example, the e-commerce website may be associated with an online shopping website through which a user can purchase and/or view items (e.g., books, movies, music, merchandise, games, etc.). In some implementations, the e-commerce website tracks what items a user has viewed, purchased, shared, not purchased, rated, etc. The e-commerce website may communicate with the recommendation server 102 to provide recommendations to a user regarding products for the user to purchase, view, share, etc.

In another example, the online service 116 hosted by the item server 108 may be a travel services web site that may be associated with an online travel website or broker, through which one can view and/or purchase flights, hotels, rental cars, etc. The travel services website may record user, item, and interaction data and communicate with the recommendation server 102 to provide recommendations to a user regarding destinations, flights, hotels, cruises, events, etc.

Additionally, it should be noted that the list of items and recommendations provided as examples for the online service 116 above are not exhaustive and that others are contemplated in the techniques described herein. Other examples of online services 116 that provide access to content items may include online banking, health services, search engine, social networking, electronic messaging service, maps, cloud storage service, online information database service, etc. Although only a single item server 108 is shown in FIG. 1, it should be understood that there may be a number of item servers 108 hosting the same or different online services or a server cluster, which may be load balanced.

The data collector 110 is a server or service which collects data and/or analysis from other servers coupled to the network 106. In some implementations, the data collector 110 may be a first or third-party server (that is, a server associated with a separate company or service provider), which mines data, crawls the Internet, and/or obtains data from other servers. For example, the data collector 110 may collect user data, item data, and/or user-item interaction data from the item server 108, provide it to other computing devices, such as the recommendation server 102 and/or perform analysis on it as a service. In some implementations, the data collector 110 may be a data warehouse or belong to a data repository owned by an organization. In some implementations, the data collector 110 may receive data, via the network 106, from one or more of the item server 108 and the client device 114. In some implementations, the data collector 110 may receive data from real-time or streaming data sources.

The data store 112 is coupled to the data collector 110 and comprises a non-volatile memory device or similar permanent storage device and media. The data collector 110 stores the data in the data store 112 and, in some implementations, provides access to the recommendation server 102 to obtain the data collected by the data store 112 (e.g. training data, response variables, tuning data, test data, user data, experiments and their results, learned parameter settings, system logs, etc.).

Although only a single data collector 110 and associated data store 112 is shown in FIG. 1, it should be understood that there may be any number of data collectors 110 and associated data stores 112. It should also be recognized that a single data collector 110 may be associated with multiple homogenous or heterogeneous data stores (not shown) in some implementations. For example, the data store 112 may include a relational database for structured data and a file system (e.g. HDFS, NFS, etc.) for unstructured or semi-structured data. It should also be recognized that the data store 112, in some implementations, may include one or more servers hosting storage devices (not shown).

In some implementations, the servers 102, 108, and 110 may each be a hardware server, a software server, or a combination of software and hardware. In some implementations, the servers 102, 108, and 110 may each be one or more computing devices having data processing (e.g., at least one processor), storing (e.g., a pool of shared or unshared memory), and communication capabilities. For example, the servers 102, 108, and 110 may include one or more hardware servers, server arrays, storage devices and/or systems, etc. Also, instead of or in addition, the servers 102, 108, and 110 may each implement their own API for the transmission of instructions, data, results, and other information between the servers 102, 108, and 110 and an application installed or otherwise implemented on the client device 114. In some implementations, the servers 102, 108, and 110 may include one or more virtual servers, which operate in a host server environment and access the physical hardware of the host server including, for example, a processor, memory, storage, network interfaces, etc., via an abstraction layer (e.g., a virtual machine manager). In some implementations, one or more of the servers 102, 108, and 110 may include a web server (not shown) for processing content requests, such as a Hypertext Transfer Protocol (HTTP) server, a Representational State Transfer (REST) service, or other server type, having structure and/or functionality for satisfying content requests and receiving content from one or more computing devices that are coupled to the network 106.

The network 106 is a conventional type, wired or wireless, and may have any number of different configurations such as a star configuration, token ring configuration or other configurations known to those skilled in the art. Furthermore, the network 106 may comprise a local area network (LAN), a wide area network (WAN) (e.g., the Internet), and/or any other interconnected data path across which multiple devices may communicate. In yet another implementation, the network 106 may be a peer-to-peer network. The network 106 may also be coupled to or include portions of a telecommunications network for sending data in a variety of different communication protocols. In some instances, the network 106 includes Bluetooth communication networks or a cellular communications network for sending and receiving data including via short messaging service (SMS), multimedia messaging service (MMS), hypertext transfer protocol (HTTP), direct data connection, wireless application protocol (WAP), electronic mail, etc.

The client devices 114a . . . 114n include one or more computing devices having data processing and communication capabilities. In some implementations, a client device 114 may include a processor (e.g., virtual, physical, etc.), a memory, a power source, a communication unit, and/or other software and/or hardware components, such as a display, graphics processor (for handling general graphics and multimedia processing for any type of application), wireless transceivers, keyboard, camera, sensors, firmware, operating systems, drivers, various physical connection interfaces (e.g., USB, HDMI, etc.). The client device 114a may couple to and communicate with other client devices 114n and the other entities of the system 100 via the network 106 using a wireless and/or wired connection.

A plurality of client devices 114a . . . 114n are depicted in FIG. 1 to indicate that the recommendation server 102 and/or other components (e.g., 108, 110) of the system 100 may aggregate data from, provide recommendations for, and/or serve information to a multiplicity of users on a multiplicity of client devices 114a . . . 114n. In some implementations, the plurality of client devices 114a . . . 114n may include a browser application through which a client device 114 interacts with the item server 108, an application installed enabling the client device 114 to couple and interact with the item server 108, may include a text terminal or terminal emulator application to interact with the item server 108, or may couple with the item server 108 in some other way. In the case of a standalone computer implementation of the system 100, the client device 114 and recommendation server 102 are combined together and the standalone computer may, similar to the above, generate a user interface either using a browser application, an installed application, a terminal emulator application, or the like. In some implementations, a single user may use more than one client device 114, which the recommendation server 102 (and/or other components of the system 100) may track and provide recommendations to the user on each device. For example, the item server 108 may track the behavior of a user across multiple client devices 114. In another implementation, the recommendation server 102 (and/or other components of the system 100) may determine features of multiple users using different client devices 114.

Examples of client devices 114 may include, but are not limited to, mobile phones, tablets, laptops, desktops, netbooks, server appliances, servers, virtual machines, TVs, set-top boxes, media streaming devices, portable media players, navigation devices, personal digital assistants, etc. While two client devices 114a and 114n are depicted in FIG. 1, the system 100 may include any number of client devices 114. In addition, the client devices 114a . . . 114n may be the same or different types of computing devices.

It should be understood that the present disclosure is intended to cover the many different implementations of the system 100 that include the network 106, the recommendation server 102, the item server 108 and associated item data store 118, the data collector 110 and associated data store 112, and one or more client devices 114. In a first example, the training recommendation server 102, the item server 108, and the data collector 110 may each be dedicated devices or machines coupled for communication with each other by the network 106. In a second example, any one or more of the servers 102, 108, and 110 may each be dedicated devices or machines coupled for communication with each other by the network 106 or may be combined as one or more devices configured for communication with each other via the network 106. For example, the recommendation server 102 and the item server 108 may be included in the same server. In a third example, any one or more of the servers 102, 108, and 110 may be operable on a cluster of computing cores in the cloud and configured for communication with each other. In a fourth example, any one or more of one or more servers 102, 108, and 110 may be virtual machines operating on computing resources distributed over the internet.

While the recommendation server 102 and the item server 108 are shown as separate devices in FIG. 1, it should be understood that, in some implementations, the recommendation server 102 and the item server 108 may be integrated into the same device or machine. Particularly, where the recommendation server 102 and the item server 108 are performing online learning, a unified configuration is preferred. While the system 100 shows only one device 102, 108, 110, and 114 of each type, it should be understood that there could be any number of devices of each type to collect and provide information. Moreover, it should be understood that some or all of the elements of the system 100 may be distributed and operate on a cluster or in the cloud using the same or different processors or cores, or multiple cores allocated for use on a dynamic as-needed basis.

### Example Recommendation Server 102

Referring now to FIG. 2, an example of a recommendation server 102 is described in more detail according to one implementation. The illustrated recommendation server 102 comprises a processor 202, a memory 204, a display module 206, a network I/F module 208, an input/output device 210 and a storage device 212 coupled for communication with each other via a bus 220. The recommendation server 102 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the recommendation server 102 may include various operating systems, sensors, additional processors, and other physical configurations.

The processor 202 comprises an arithmetic logic unit, a microprocessor, a general purpose controller, a field programmable gate array (FPGA), an application specific integrated circuit (ASIC), or some other processor array, or some combination thereof to execute software instructions by performing various input, logical, and/or mathematical operations to provide the features and functionality described herein. The processor 202 processes data signals and may comprise various computing architectures including a complex instruction set computer (CISC) architecture, a reduced instruction set computer (RISC) architecture, or an architecture implementing a combination of instruction sets. The processor(s) 202 may be physical and/or virtual, and may include a single core or plurality of processing units and/or cores. Although only a single processor is shown in FIG. 2, multiple processors may be included. It should be understood that other processors, operating systems, sensors, displays and physical configurations are possible. The processor 202 may also include an operating system executable by the processor 202 such as but not limited to WINDOWS®, Mac OS®, or UNIX® based operating systems. In some implementations, the processor(s) 202 may be coupled to the memory 204 via the bus 220 to access data and instructions therefrom and store data therein. The bus 220 may couple the processor 202 to the other components of the recommendation server 102 including, for example, the display module 206, the network I/F module 208, the input/output device(s) 210, and the storage device 212.

The memory 204 may store and provide access to data to the other components of the recommendation server 102. The memory 204 may be included in a single computing device or a plurality of computing devices. In some implementations, the memory 204 may store instructions and/or data that may be executed by the processor 202. For example, as depicted in FIG. 2, the memory 204 may store the recommendation unit 104, and its respective components, depending on the configuration. The memory 204 is also capable of storing other instructions and data, including, for example, an operating system, hardware drivers, other software applications, databases, etc. The memory 204 may be coupled to the bus 220 for communication with the processor 202 and the other components of recommendation server 102.

The instructions stored by the memory 204 and/or data may comprise code for performing any and/or all of the techniques described herein. The memory 204 may be a dynamic random access memory (DRAM) device, a static random access memory (SRAM) device, flash memory or some other memory device known in the art. In some implementations, the memory 204 also includes a non-volatile memory such as a hard disk drive or flash drive for storing information on a more permanent basis. The memory 204 is coupled by the bus 220 for communication with the other components of the recommendation server 102. It should be understood that the memory 204 may be a single device or may include multiple types of devices and configurations.

The display module 206 may include software and routines for sending processed data, analytics, or item recommendations for display to a client device 114, for example, to allow an administrator or user to interact with the recommendation server 102. In some implementations, the display module 206 may include hardware, such as a graphics processor, for rendering interfaces, data, analytics, or recommendations.

The network I/F module 208 may be coupled to the network 106 (e.g., via signal line 214) and the bus 220. The network I/F module 208 links the processor 202 to the network 106 and other processing systems. In some implementations, the network I/F module 208 also provides other conventional connections to the network 106 for distribution of files using standard network protocols such as transmission control protocol and the Internet protocol (TCP/IP), hypertext transfer protocol (HTTP), hypertext transfer protocol secure (HTTPS) and simple mail transfer protocol (SMTP) as should be understood to those skilled in the art. In some implementations, the network I/F module 208 is coupled to the network 106 by a wireless connection and the network I/F module 208 includes a transceiver for sending and receiving data. In such an alternate implementation, the network I/F module 208 includes a Wi-Fi transceiver for wireless communication with an access point. In another alternate implementation, the network I/F module 208 includes a Bluetooth® transceiver for wireless communication with other devices. In yet another implementation, the network I/F module 208 includes a cellular communications transceiver for sending and receiving data over a cellular communications network such as via short messaging service (SMS), multimedia messaging service (MIMS), hypertext transfer protocol (HTTP), direct data connection, wireless application protocol (WAP), email, etc. In still another implementation, the network I/F module 208 includes ports for wired connectivity such as but not limited to USB, SD, or CAT-5, CAT-5e, CAT-6, fiber optic, etc.

The input/output device(s) (“I/O devices”) 210 may include any device for inputting or outputting information from the recommendation server 102 and may be coupled to the system either directly or through intervening I/O controllers. An input device may be any device or mechanism of providing or modifying instructions in the recommendation server 102. For example, the input device may include one or more of a keyboard, a mouse, a scanner, a joystick, a touchscreen, a webcam, a touchpad, a touchscreen, a stylus, a barcode reader, an eye gaze tracker, a sip-and-puff device, a voice-to-text interface, etc. An output device may be any device or mechanism of outputting information from the recommendation server 102. For example, the output device may include a display device, which may include light emitting diodes (LEDs). The display device represents any device equipped to display electronic images and data as described herein. The display device may be, for example, a cathode ray tube (CRT), liquid crystal display (LCD), projector, or any other similarly equipped display device, screen, or monitor. In one implementation, the display device is equipped with a touch screen in which a touch sensitive, transparent panel is aligned with the screen of the display device. The output device indicates the status of the recommendation server 102 such as: 1) whether it has power and is operational; 2) whether it has network connectivity; 3) whether it is processing transactions. Those skilled in the art should recognize that there may be a variety of additional status indicators beyond those listed above that may be part of the output device. The output device may include speakers in some implementations.

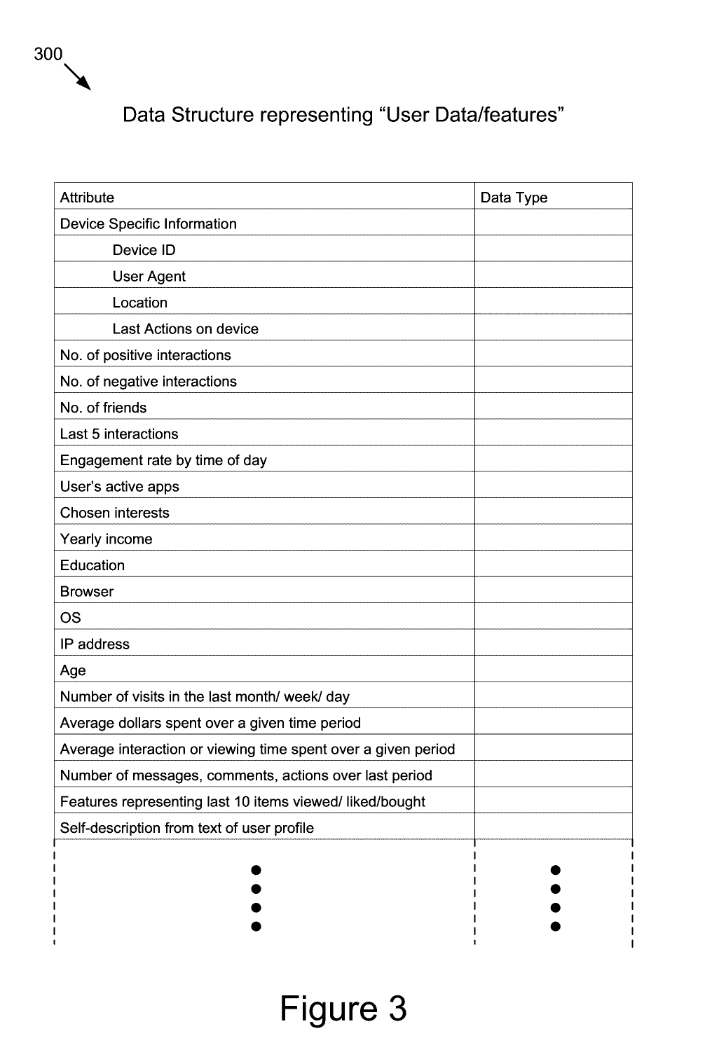

The storage device 212 is an information source for storing and providing access to data, such as the data described in reference to FIGS. 3-5 and including a plurality of datasets, model(s), constraints, etc. The data stored by the storage device 212 may be organized and queried using various criteria including any type of data stored therein. The storage device 212 may include data tables, databases, or other organized collections of data. The storage device 212 may be included in the recommendation server 102 or in another computing system and/or storage system distinct from but coupled to or accessible by the recommendation server 102. The storage device 212 may include one or more non-transitory computer-readable mediums for storing data. In some implementations, the storage device 212 may be incorporated with the memory 204 or may be distinct therefrom. In some implementations, the storage device 212 may store data associated with a relational database management system (RDBMS) operable on the recommendation server 102. For example, the RDBMS could include a structured query language (SQL) RDBMS, a NoSQL RDMBS, various combinations thereof, etc. In some instances, the RDBMS may store data in multi-dimensional tables comprised of rows and columns, and manipulate, e.g., insert, query, update and/or delete, rows of data using programmatic operations. In some implementations, the storage device 212 may store data associated with a Hadoop distributed file system (HDFS) or a cloud based storage system such as Amazon™ S3.

The bus 220 represents a shared bus for communicating information and data throughout the recommendation server 102. The bus 220 may represent one or more buses including an industry standard architecture (ISA) bus, a peripheral component interconnect (PCI) bus, a universal serial bus (USB), or some other bus known in the art to provide similar functionality which is transferring data between components of a computing device or between computing devices, a network bus system including the network 106 or portions thereof, a processor mesh, a combination thereof, etc. In some implementations, the processor 202, memory 204, display module 206, network I/F module 208, input/output device(s) 210, storage device 212, various other components operating on the recommendation server 102 (operating systems, device drivers, etc.), and any of the components of the recommendation unit 104 may cooperate and communicate via a communication mechanism included in or implemented in association with the bus 220. The software communication mechanism may include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

As depicted in FIG. 2, the recommendation unit 104 may include and may signal the following to perform their functions: a data collection module 220 that obtains data from one or more of the storage device 212, the item server 108, and the input/output device 210 and passes it on to the data preparation module 226, a data preparation module 226 that obtains the data from the data collection module 220, fuses the data in a table form to create a dataset that is derived from user, item, and user-item interactions, and then passes it on to the model generation module 232, a collaborative filtering module 228 to augment the model predictions produced by the model generation module 232, a popularity-based modeling module 230 to augment the model predictions produced by the model generation module 232, a model generation module 232 that takes the prepared data from 220 and/or 226 and launches the relevant modeling module based upon the use case. The model generation module 232 consists of (i) supervised learning module 234a that is invoked if the data collected is from the same platform upon which the recommendations are to be made, (ii) supervised learning module 234b that is invoked if the data collected is from a different platform than that platform on which the recommendations are to be made. Further, the recommendation unit 104 may include and may signal the following to perform their functions: a recommendation module 236 that is invoked to generate recommendations using the supervised learning model received from the model generation module 232 and an update module 238 that is invoked when the model is to be updated to incorporate new information in the dataset (in the form of new user-item interaction appended as rows) and a recommendation module 236. These components 220, 226, 228, 230, 232, 236, 238 and/or components thereof, may be communicatively coupled by the bus 220 and/or the processor 202 to one another and/or the other components 206, 208, 210, and 212 of the recommendation server 102. In some implementations, the components 220, 226, 228, 230, 232, 236, and/or 238 may include computer logic (e.g., software logic, hardware logic, etc.) executable by the processor 202 to provide their acts and/or functionality. In any of the foregoing implementations, these components 220, 226, 228, 230, 232, 236, and/or 238 may be adapted for cooperation and communication with the processor 202 and the other components of the recommendation server 102.

It should be recognized that the recommendation unit 104 and disclosure herein applies to and may work with Big Data, which may have billions or trillions of elements (rows×columns) or even more, and that the disclosure is adapted to scale to deal with such large datasets, resulting large models and results, while maintaining intuitiveness and responsiveness to interactions.

The data collection module 220 includes computer logic executable by the processor 202 to collect or aggregate user data, item data, and interaction data from various information sources, such as computing devices and/or non-transitory storage media (e.g., databases, servers, etc.) configured to receive and satisfy data requests. In some implementations, the data collection module 220 obtains information from one or more of the item server 108, the data collector 110 and associated data store 112, the client device 114, and other content or analysis providers. For example, the data collection module 220 sends a request to the item server 108 hosting a video sharing online service via the network I/F module 208 and the network 106 and obtains user data, item data, and/or interaction data from the item server 108. In another example, the data collection module 220 obtains user data, item data, and/or interaction data from a third-party data source, such as a data mining, tracking, or analytics service.

In some implementations, to build a recommendation system, a diverse set of data features for the users and the items are collected and aggregated. As illustrated, in some implementations, the data collection module 220 may include a text analytics module 222 and an unsupervised learning module 224.

In some implementations, the text analytics module 222 featurizes textual data associated with items and/or users. In some implementations, the text analytics module 222 obtains a text description of an item from a server (e.g., item server 108 or data collector 110) or as stored in the storage device 212 and analyzes the text associated with an item to determine features of that item. For example, the text analytics module 222 may run a bag of words on the description and/or title of an item to generate a large-dimensional sparse dataset. A bag of words is a model for processing natural language in which grammar and word order are discarded, but words are kept and used to analyze text. In some implementations, the text analytics module 222 provides the features as item data and stores it in the storage device 212 or send the features to another module for further processing. For example, the text analytics module 222 may send the text-based features to the unsupervised learning module 224. It should be understood that it is possible and contemplated that featurization of textual data associated with users may occur in a same or similar way.

In some implementations, the unsupervised learning module 224 obtains the dataset of features associated with users or items produced by the text analytics module 222 and performs featurization, for example, a singular value decomposition (SVD) feature reduction on that dataset to reduce the dimension of the text features which has a large-dimensional representation. In some implementations, the unsupervised learning module 224 accesses a dataset stored in the storage device 212 and processes the dataset to reduce the dimension of the features for use by the supervised learning module 234. In some implementations, the text analytics module 222 instructs the unsupervised learning module 224 that the feature set is too large and the unsupervised learning module 224 performs the singular value decomposition feature reduction in response to the indication, by the text analytics module 222, that the feature set is too large. Finally, the text analytics module 222 clusters the resulting dataset to reduce the text features to one or more single categorical features that represent groupings or categories. In this way, there is a simplified representation of text in terms of a simple set of categories.

In some implementations, the data collection module 220 collects user data using user profile information of users registered to the recommendation server 102 and/or from the item server 108 accessible by the recommendation server 102. For example, the user profile information may include user data, such as age, education, profession, geographic location, user interests, etc. The data collection module 220 determines a user ID for a user for whom it is obtaining or updating data. The data collection module 220 uses the user ID to access a server or service and obtain profile information. In some implementations, the data collection module 220 identifies or classifies users and/or items not according to an ID, but according to the user/item attributes. In some implementations, the data collection module 220 collects user data using information logged by one or more of the servers 102, 108, and 110. For example, the information logged by the servers 102, 108, and 110 may include Internet protocol (IP) address of client device 114, browser type, operating system on the client device 114, information registered or tracked (e.g., past visits, day and time of visits, and such) by browser cookies accessible to the servers, etc. In some implementations, the data collection module 220 stores the profile information and logged information in a storage device 212, for example, in a matrix or series of rows.

In some implementations, not only may the data collection module 220 organize user data attributes into groupings, but the data collection module 220 may also obtain the user data attributes from groupings or aggregations. The data collection module 220 determines a group of users with similar user attributes. For example, the group may have users with similar attributes, such as age, geolocation, education, interests, etc. The similarity can be as simple as users within a range of age in years or as complex as similarity metric based on a multitude of user features or obtained by clustering. The data collection module 220 identifies user information from such a group of users. For example, the data collection module 220 identifies an average dollar amount spent by the group of similar users, a favorite category of the group of similar users, etc. In another example, for a user who is 27 years old, the data collection module 220 may identify a data feature for the user which is an “average rating of item by users in an age range of 25-30.”

As shown in the example graphical representation 300 of FIG. 3, the data collection module 220 collects user data attributes by virtue of users interacting with an application or browser accessing the item server 108 on a client device 114, filling out surveys, publicly known information about the user, etc. For example, the data collection module 220 groups user data as and/or include (1) device specific information, such as device identifier (e.g. electronic serial number, type of device, etc.), user agent, location, last actions performed on the device, etc., (2) user demographics, such as age, education, chosen interests, number of friends, and other profile specific information, (3) logged user information, such as operating system, Internet protocol (IP) address, browser, number of positive interactions, number of negative interactions, last five interactions, engagement rate by time of day, user's active applications, number of visits in the last month, week, or day, average interaction time over a time period, etc., (4) user feedback, such as comments, shares, likes, dislikes, favorites, actions, etc., and so forth.

In some implementations, the data collection module 220 collects item data for one or more items, which may occur in the same, or similar, way as, or along with, the collection of user data discussed above. In some implementations, the data collection module 220 collects item data using item description text from a server or service (e.g., item server 108) accessible by the recommendation server 102. For example, the data collection module 220 obtains product description and title for videos, books, and other merchandise from an ecommerce website. The data collection module 220 instructs the text analytics module 222 to generate text features from the description text and title, for example, vector space representation of the description text and title and stores it as item data. In some implementations, the data collection module 220 obtains user comments, such as comments on an item, and comment features (e.g., metadata) from a server or service. The data collection module 220 generates item data from the comments and comment features. For example, the item data may include the number of comments, vector space representations of text comments (generated by text analytics module 222), sentiment features generated from the text comments using natural language processing, etc.

In some implementations, the data collection module 220 obtains item tag or category information on items from the server or service and determines a genre, class or category of the item as item data. For example, a tag or category reflecting a genre of video, music, books, etc. may be associated with an item in an ecommerce website. In another example, the tag can be chosen by the users of the service or by experts. In some implementations, the data collection module 220 obtains author or creator information associated with an item from a server or service and generates item data. The author or creator information may include the name of a creator as recorded on the server or service or a third party source (e.g., the data collector 110), information about the creator as collected from a third party source or as specified by a user or expert. For example, the information about the creator could include the popularity of items created or posted by the creator (e.g., in terms of one or more of views, likes, purchases, and/or reviews provided on the server or service or a third party server or service), genres of other items by the same creator, and/or other information pertaining to an author or creator of an item, which the data collection module 220 obtains from a server or service for inclusion or transformation as item data.

In some implementations, the data collection module 220 obtains item popularity information from a server or service. For example, item popularity information may include view count, number of likes, dislikes, or purchases, popularity history (historical number of likes, dislikes, purchases, views, or a current rate of change thereof), etc. In some implementations, the data collection module 220 obtains item content feature information from a server or service. For example, the item content features may include the length of a video or song, notable frame in the video, melodic or rhythmic features of a song extracted automatically or input by an expert, color features of a video, the topic of an article extracted via topic modeling, etc. In some implementations, the data collection module 220 generates item data features from the popularity information and the item content feature information.

Similarly, as in the case of user attributes, the data collection module 220 may obtain item data attributes from groupings or aggregations. The data collection module 220 determines a group of items having similar item attributes. The data collection module 220 identifies item attributes from the group of items. For example, the data collection module 220 identifies item data, such as average age of users who are interacting with the item, average price of similar items, sales rates of similarly rated and priced products, interaction time by users of a similar demographic, or similar groupings of other attributes. In another example, for a given item, the data collection module 220 may determine an item attribute which is the average age of users who watched the item (e.g., a video). The average age of users may be un-weighted or weighted based on the length of time watched.

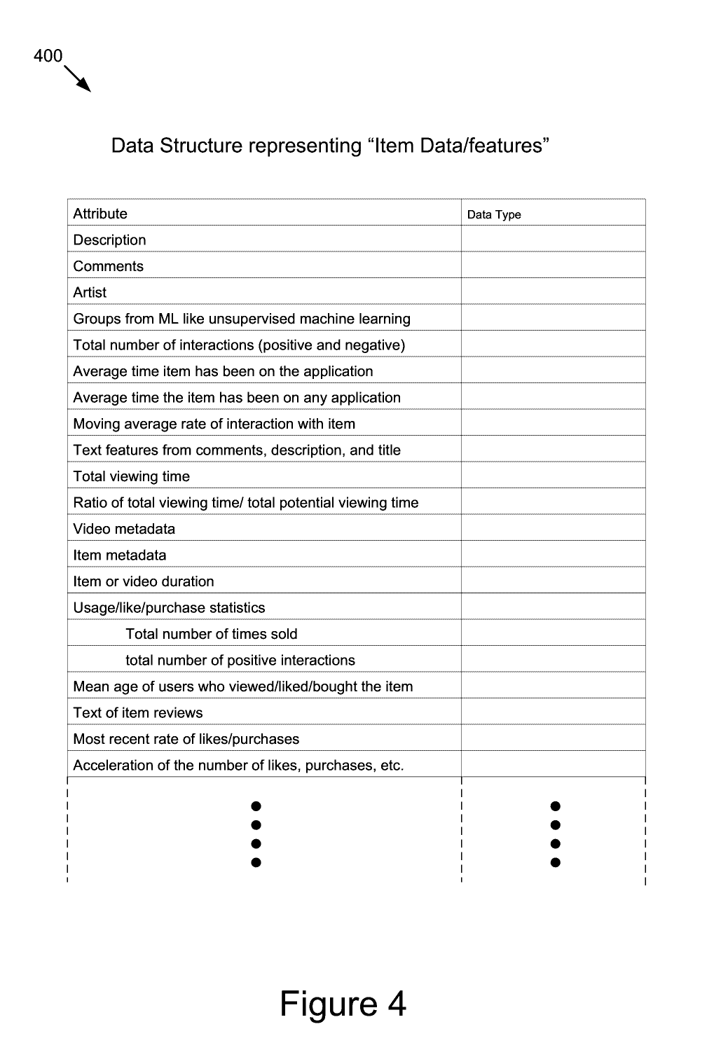

As shown in the example graphical representation 400 of FIG. 4, the data collection module 220 aggregates item data attributes by virtue of users interacting with a plurality of items, from textual analysis, from preprogrammed item data, or from other methods described herein or known in the art. For example, the data collection module 220 groups item data as and/or include (1) item metadata: title, description, tags, channel, genre, category, author, comments, etc., (2) item usage/like/purchase statistics: total number of interactions, moving average rate at which the item is being interacted with, total number of times sold, most recent purchase/like, number of views or watch count or rating on server or services, rate of likes and/or purchases, etc., (3) total viewing time or duration, ratio of total viewing time and total potential viewing time, average time the item has been on application, etc., and (4) groups identified through machine learning, such as unsupervised learning techniques, etc.

In some implementations, the data collection module 220 collects user-item interaction data for one or more users and items, which may be performed in a manner similar to, or along with, the collection of user data and/or item data discussed above. In some implementations, the storage device 212 may already contain user data and item data, but the data collection module 220 updates the interaction data to include an interaction of the user with the item (e.g., as received, or, in some instances, as the interaction occurs).

In some implementations, the data collection module 220 obtains actions performed by one or more users on items from a server or service. For example, the item server 108, the data collector 110, or the client device 114, or a component thereof, records user interactions with items, such as actions including likes, dislikes, purchases, skips, views, length of views, etc. In some implementations, the data collection module 220 obtains actions performed by the one or more users on items which were recommendations suggested to the users by the server or service. For example, the data collection module 220 obtains whether the user action was to skip, or view, or like, or dislike, or purchase the recommended items. Taking watching videos as an example, the data collection module 220 identifies which recommended videos were watched by the user and which recommended videos were skipped by the user together with time of day information from the obtained actions. In another example, the data collection module 220 determines flip-through behavior while watching a recommended video from the obtained actions. The flip-through behavior indicates user action including how many videos were flipped through or browsed while a given video was watched by the user and at what timestamps.

In some implementations, the data collection module 220 obtains the total interaction time or duration by a user with each item from a server or service. For example, the data collection module 220 obtains how long the user watched each video from the item server 108. In some implementations, the data collection module 220 obtains the number of views of an item by a user and/or a detailed view history. For example, the data collection module 220 obtains how many times the user viewed a webpage for an item and when the user viewed the webpage for the item. In some implementations, the data collection module 220 obtains the time spent by the user interacting with (e.g., reading) reviews of an item from a server or service.

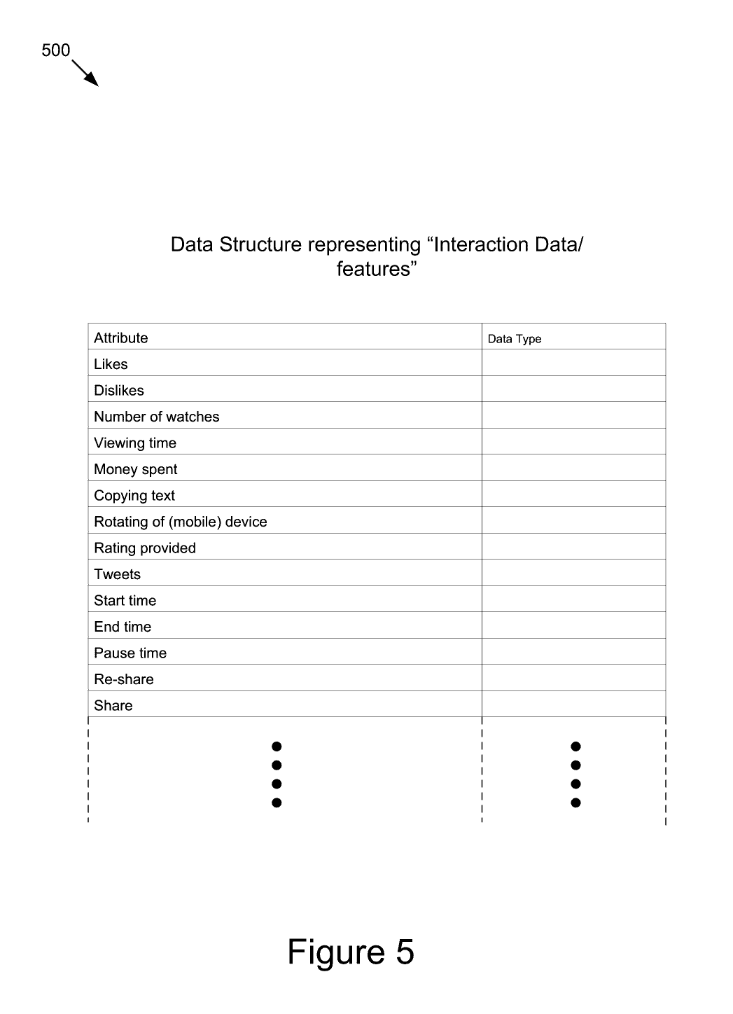

As shown in the example graphical representation 500 of FIG. 5, the data collection module 220 aggregates an interaction data list, for example, that represents any action a user can potentially take with an item, which may be obtained, for example from a user's purchase history, user device, clickstream, internet cookies, view history, etc., as described elsewhere herein. For example, the data collection module 220 collects as user-item interaction data and/or includes likes, dislikes, number of watches, viewing time, money spent, copying text, rotating of mobile device, rating, tweets, start time of interaction, end time of interaction, pause time, share, re-share, etc. It should also be understood, that many interactions and types of interactions other than those listed in FIG. 5 and discussed in this disclosure are possible and contemplated by the techniques described herein.

It should be understood that the operations of obtaining user data, item data, and user-item interaction data may be performed simultaneously. For example, the data collection module 220 obtains a single dataset including each of the user, item, and interaction data or that they may occur over time in response to users' repeated action with one or more servers or services (e.g., 108 or 110) which collect such data about users. It should be understood that other configurations are possible and that the data collection module 220 may perform operations of the other components of the system 100 or that other components of the system may perform operations described as being performed by the data collection module 220. Additionally, it should be understood that because a diverse set of features should be recorded in order to create an accurate recommendation system, more, fewer, or different features than the user, item, and item interaction data discussed herein may be recorded, stored, and used according to the techniques described herein.

As illustrated, FIGS. 3-5 depict examples implementations of user, item, and user-item interaction data or features respectively, which are collected according to the methods described herein to be used to facilitate the creation of a recommendation system. It should be understood that the data discussed in reference to and represented in FIGS. 3-5 is provided as an example, is not intended to be limiting, and other data and data types are possible and contemplated in the techniques described herein.

The data collection module 220 collects data and performs operations described throughout this specification, especially in reference to FIGS. 3-9.

The data collection module 220 is coupled to the storage device 212 to store, obtain, and/or manipulate data stored therein and may be coupled to the other components of the recommendation unit 104 to exchange information therewith. In some implementations, the data collection module 220 may store, obtain, and/or manipulate the user data, item data, and/or interaction data aggregated by it in the storage device 212, and/or may provide the data aggregated and/or processed by it to data preparation module 226 and/or the other components of the recommendation unit 104 (e.g., preemptively or responsive to a procedure call, etc.).

The data preparation module 226 includes computer logic executable by the processor 202 to aggregate, organize, and augment user data, item data, and interaction data as collected by the data collection module 220. In some implementations, the data preparation module 226 is coupled to the storage device 212 to organize and combine user, item, and interaction data into rows, determine negative interaction data, and otherwise organize and augment the data collected by the data collection module 220.

In some implementations, the data preparation module 226 obtains user data, item data, and interaction data from storage device 212 and combines the user data, item data, and interaction data into rows of a dataset that will be used for training a supervised learning model. In some implementations, the data preparation module 226 creates a table in which to organize the user, item, and interaction data and stores the table in the storage device 212. A schematic example of the rows of a dataset generated by the data preparation module 226 are included in the following paragraph and include a selection of possible columns which may be used in building a model. Example columns are shown in brackets as [column description] and the split between user data, item data, and interaction data in a row is shown by a pair of asterisks as [**]. The last column ([User response to current item]) is the “output” column that the model will be trained to predict. All the other columns are “input” columns.

Row 1: [UserID], [User age], [User income level], [User interests], [Average dollar amount spent by similar users], [Favorite item categories of similar users], . . . [**] [ItemID], [Item category], [Item tags], [Item view count], [Item number of likes], [Item current rate of views], [Item description feature vector], [List of 5 items most similar to current item in terms of content], [List of 5 items most similar to current item in terms of genre], [List of 5 items most similar to current item in terms of category], [List of 5 items most similar to current item in terms of ratings], [Average age of users having interacted with the item], . . . [**] Features generated from list of past items bought or liked by user, such as: [Top 5 item categories most liked by user], [Top 5 item categories most viewed by user], [Top 5 item categories most bought by user], [Top 10 Items (most highly rated) by user], [Bottom 10 items (most lowly rated) by user], [Most recent 10 items bought by user], [Most recent 10 items viewed by user], [Most recent 10 items highly rated by user], [Top 10 items most similar to current item in terms of ratings], [Top 5 items rated most highly by top 5 users who are most similar to current user in terms of ratings or other similarity metric], [User response to past recommended items], [User response to current item (e.g., like, dislike, view, skip, ignore, total interaction time, purchase, no purchase, rating, money spent, profit resulting from purchase)], etc. It should be understood that the above is provided as an example only and is not intended to be limiting. For example, although the similarity metric above is described in terms of ratings, particular attributes, and particular user-item interactions, other interactions, demographics, aggregated groupings, usage behaviors, and attributes are possible and contemplated by the techniques described herein.

In some implementations, the data preparation module 226 performs imputation to replace the missing values in the dataset. For example, a set of users may lack certain profile and/or interaction data. The missing value imputation technique may include but not limited to generating a mean value and/or median value imputation of another feature or column in the dataset, adding two or more features in the dataset, and normalizing the column values to replace the missing values in the dataset. In some implementations, the data preparation module 226 creates a new column and adds the new column as input column in the dataset. For example, the data preparation module 226 obtains a prediction of a rating for an item by a user from the collaborative filtering module 228 and adds the prediction as another “input” column in the dataset. The data preparation module 226 may prepare the dataset as thoroughly as computationally practical.

In some implementations, the data preparation module 226 determines whether negative interaction data for one or more users in the dataset can be obtained or created. For example, the negative interaction data may serve as a negative example in a training set for building a model. The data preparation module 226 may make the determination based on one or more factors, such as whether there was a prior rating system (e.g., a like, dislike, etc.) that is in place for the users and/or items, whether there is a recommendation system in place, if there is available information about item popularity, views, presentations to users, etc. For example, the data preparation module 226 may determine whether there were prior recommendations of items made to the user and whether the user rejected, skipped, or ignored the recommended items. This kind of negative interaction data can be valuable for building an accurate recommendation system. If the negative interaction data can be obtained or created, the data preparation module 226 obtains or creates the negative interaction data. For example, the data preparation module 226 obtains the negative interaction data already stored in the storage device 212 or on a server or service, such as the item server 108 or the data collector 110.

In some implementations, the data preparation module 226 may artificially create negative training examples by taking the most popular items the user has not bought or viewed and include those items in one or more rows for that particular user as negative feedback. For example, the data preparation module 226 may artificially create negative (e.g., unwatched) examples in a dataset of videos, which does not contain negative examples. This can be performed by considering a reduced set of active users and creating one row for an active video each user did not watch. An active user may be a user whose usage statistics is above median usage and an active video is one whose viewing statistics is above median views. An active user and active video can be so labeled either in overall terms or in a specific duration of time. For example, the data preparation module 226 identifies 250,000 active users and 1000 active videos. The data preparation module 226 creates a row for each of the 250,000 active users for each of the 1000 active videos, for example, there can be 250 million rows (250,000×1000) of negative examples. These negative examples can be used to create models and recommendations in the same way as the positive examples discussed elsewhere herein.

The collaborative filtering module 228 includes computer logic executable by the processor 202 to perform collaborative filtering to featurize, that is, determine features for items (or, in some implementations, for users). For example, the collaborative filtering module 228 may access user, item, and interaction data in the storage device 212 and augment it to include predictions and/or additional features. The collaborative filtering module 228 sends these predictions and/or additional features to the data collection module 220 and data preparation module 226 for inclusion in the dataset as input columns as described elsewhere herein.

In some implementations, the collaborative filtering module 228 may featurize (e.g., determine or improve features) the item data. For example, if the dataset includes sufficient data that a collaborative filtering (e.g., item-based collaborative filtering) algorithm can predict how some users would rate an item, the collaborative filtering module 228 can determine predictions features (e.g., ratings) of items and use those predictions as another input column in the dataset. The collaborative filtering module 228 can store or provide to the data collection module 220 and/or data preparation module 226 the additional input for storage in the dataset. A suite of similarity metrics may be used to optimize the solution for an item-based collaborative filtering model by the collaborative filtering module 228.

In some implementations, the collaborative filtering module 228 determines rating-based similarities, as in collaborative filtering, or item feature based similarities, such as the L2 distance between vector representations of item features. For example, the collaborative filtering module 228 determines a list of five items most similar to an item under consideration in terms of one or more of ratings, content, views, genre, etc. In another example, the collaborative filtering module 228 determines top 10 items most similar to the item under consideration in terms of one or more of ratings, purchase, views, etc. In another example, the collaborative filtering module 228 determines top five items most highly rated by top five users who are most similar to the target user in terms of one or more of ratings, demographics, geolocation, etc. In some implementations, the collaborative filtering module 228 sends a candidate set of items to the recommendation module 236 for the recommendation module 236 to select candidate items to consider for each user, in the supervised learning approach as described herein.

The popularity-based modeling module 230 includes computer logic executable by the processor 202 to augment a model created by the model generation module 232 with a popularity-based naïve model. In some implementations, the popularity-based naïve model encodes the simple logic of recommending the most popular items (i.e., global popularity) among all the users aggregated in the dataset. In some implementations, the popularity-based naïve model recommends items that have gained popularity within a group of similar users and/or items selected for a specific business objective. The model from the popularity-based modeling module 230 forms a non-personalized model that makes baseline recommendations, which may be used as a fall-back by the recommendation module 236 described herein when the sophisticated supervised learning model does not make predictions of enough confidence to suggest as recommendations to the user. Another use of this simple model is to select candidate items to consider for each user, in the supervised learning approach as described herein.

The model generation module 232 may include computer logic executable by the processor 202 to create models based on the data collected by the data collection module 220 and data prepared by the data preparation module 226. The model generation module 232 (and/or components thereof) may be called by the recommendation unit 104 to build models, in response to which it accesses user, item, and interaction data stored in the storage device 212 and creates models based on the data. In some implementations, the model generation module 232 stores the models in the storage device 212 for access by other components of the recommendation server 102. In some implementations, the model generation module 232 sends the models to other components of the recommendation unit 104 to further augment the models or create a list of recommendations for a user using the models. As illustrated, the model generation module 232 may include a supervised learning module 234a and, in some instances, a supervised learning module for surrogate data 234b.

The supervised learning module 234a selects supervised learning methods and trains models based on user, item, and interaction data collected by the recommendation server 102. The supervised learning module for surrogate data 234b is similar to the supervised learning module 234a, but rather than creating models based on data collected by the recommendation server 102, it performs the same functions on data collected by another system, such as the data collector 110 or the item server 108. It should be understood that, although the techniques described in this disclosure are described primarily in reference to the supervised learning module 234a, they may be equally be applicable to the supervised learning module for surrogate data 234b.

In some implementations, the supervised learning module 234a selects or determines (e.g., based on administrative settings or attributes of the dataset or user, such as the information that has been collected) one or more supervised learning methods, such as a gradient boosted tree; a random forest; a support vector machine; a neural network; logistic regression (with regularization), linear regression (with regularization); stacking; and/or other supervised learning models known in the art. In some implementations, the supervised learning module 234a selects a supervised learning method to handle missing data in the dataset. For example, certain rows, portions of rows, or portions of columns in the dataset may be incomplete, such as the education level of a user or previous items rated (e.g., liked, approved, disliked, etc.). The missing data may provide an impetus for selecting certain models or for altering the dataset. For example, the supervised learning module 234a may select a gradient boosted tree model which can natively be able to deal with missing values. In another example, the supervised learning module 234a performs or instructs the data preparation module 226 to perform imputation to replace missing values, so that other types of models based on other supervised learning methods may be used. The use of missing value-tolerant supervised learning methods and/or imputation techniques allows the recommendation system implemented by the recommendation unit 104 to generate recommendations for new target users for whom a majority of profile information and/or user-item interaction data are missing.

In some implementations, the supervised learning module 234a obtains one or more business requirements or rules. Specific business requirements/rules may be embedded into the optimization of a model resulting in a constrained optimization. For example, the recommendation system using a supervised learning algorithm or model may be required to adhere to certain rules, such as showing at least a certain number of products from certain vendors or categories. In another example, it may be required to show at least a few products below a given price point. The business requirements or rules may be provided by a user (e.g., a stakeholder or administrator) who is configuring the recommendation unit 104. The business rules may affect which supervised learning methods are chosen by the supervised learning module 234a to maximize the overall objective. In some implementations, the supervised learning module 234a selects a particular supervised learning method based on the obtained business rule.

In some implementations, the supervised learning module 234a obtains one or more business objectives to be optimized for in a model and the supervised learning module 234 selects a particular supervised learning method to build the model based on the one or more business objectives. The business objectives for which the model(s) can be optimized may include a dollar value (revenue, profit, etc.), advertising revenue, other measures of income, revenue or profit, overall engagement, total time spent on an application or user interaction time, quantity of invitations to the application sent (e.g., shared with other users), user acquisition or retention, number of user interactions, number of positive and/or negative interactions, items with the longest interaction times, etc. The supervised learning module 234a may consider a range of factors to determine the optimally tuned model. The parameters of the model may be optimized according to one or more optimization constraints, which may include business requirements or business objectives embedded into the optimization or tuning.

Taking overall profit as an example of a business objective to be optimized in a model, the supervised learning module 234a may tune parameters of the model so that products with higher margins or profits may be recommended over those with a higher likelihood of purchase, but a lower margin or profit. It should be understood that a model may not directly predict a representation of a business objective, for example, the overall revenue or profit may not be predicted for a single row in the dataset. In such cases, the supervised learning module 234 identifies a proxy value. In some implementations, the proxy value can based on a user response. In other words, the proxy value is a function of the predicted user response. For example, the proxy value can be based on an amount of time the user plays a video on a video service, a rating that the user would likely give a video, a likelihood that the user will purchase the video, or other such user responses that can be optimized for achieving the business objective.

For example, assuming two products A and B cost the consumer $90, if margin on A is $15 and the margin on B is $5, and both have a similar probability of purchase, but A's probability of purchase is slightly lower than B's probability of purchase. Here, the probability of purchase is a feature column, and so is the margin. It can be understood that the combination of probability of purchase and the margin as another feature column is possible due to featurization by the data preparation module 226. In some implementations, the model tuned by supervised learning module 234a may recommend A (even though A may have an ever so slightly lower probability of purchase) because the proxy value (e.g., margin X probability of purchase) of A is higher (or is an optimized value) compared to the proxy value of B. The supervised learning module 234a may tune the model to balance the business objective (e.g., maximize profit, maximize advertising revenue, etc.) with the likelihood of interaction to determine what constraint maximizes the objective and include that constraint in the optimization of the model. For example, the supervised learning module 234a may use algorithms to decide what price margin to likelihood of purchase ratio maximizes the profit and include that in the optimization.

In some implementations, the optimization process is specific to the supervised learning method used, so the supervised learning module 234a determines how to tune a model and tunes the parameters of the model based on the supervised learning method chosen. The optimization processes for each type of supervised learning method are known and documented in the art. For example, if a gradient boosted tree model is selected, a stepwise optimization approach is used, which attempts to find the tree that would most rapidly improve the performance at each step.

In some implementations, the supervised learning module 234a tunes a model of the chosen type by optimizing its parameters to maximize a desired aspect of performance. For example, if the supervised learning model is predicting a numerical measure of user-item interaction such as the duration of video watching by user, or the user rating of items, the L2 score (i.e. the Euclidian distance between the observed and predicted values of the interaction measure), L1 score (i.e. Manhattan distance), or other scores that quantify the discrepancy between numerical predictions and observed values can be used as a performance measure. Similarly, in the case of predicting like/dislike, or buy/not buy-type binary user-item interactions, one can use the AUC (area under the ROC curve), or other related measures as a measure of performance.

In some implementations, the supervised learning module 234a splits or filters the dataset into multiple subset datasets according to characteristics of items or users. For example, the supervised learning module 234a may split or filter the rows of the dataset according to genres of items or demographics of users. In some implementations, the supervised learning module 234a creates the subset datasets from the original dataset, for instance, using sampling with or without replacement, although other methods are possible and contemplated herein. The supervised learning module 234a generates or builds a model on the subset dataset. For example, the supervised learning module 234a builds a first model for a first group of similar target users who love action movies in the dataset and a second model for a second group of similar target users who love mini-drones in the dataset. The first group of users and the second group of users may overlap. The group of similar users in the dataset can be selected through clustering based on usage, demographics, user-item interactions, etc.

In some implementations, the supervised learning module 234a divides the dataset or subset thereof, on which the supervised learning module 234a builds a model, into a test set, a training set, and a validation set using, for example, a holdout or cross validation scheme. For example, the supervised learning module 234a divides the subset of the dataset that is associated with a group of target users who love action movies into a test set, a training set, and a validation set.

In some implementations, the supervised learning model 234a selects a subset of columns or features in the dataset for building the model. In some implementations, the selection of subset of columns and rows of the dataset for building the model can be based on the business rules and/or business objectives as described above. In some implementations, the supervised learning module 234a excludes columns from the dataset which are unknown regarding the group of target users or superfluous regarding the desired output prediction and builds the model on the restricted dataset. In one implementation, the supervised learning module 234a may only build a model on the subset of columns known about the group of target users. For example, a group of target users (e.g., a group of new users for whom a model is being built and recommendations generated using the model) lack certain profile and/or interaction data, which the supervised learning module 234a excludes from the original dataset for building the model.

In some implementations, such as in the case of new target users with some profile information, the supervised learning module 234a creates models based on the existing dataset by excluding history information (e.g., server logged information, ratings, clickstream, etc.) for a set of users, which may include non-new, existing users, in the dataset in order to make those users appear as if they are new users with some profile information (e.g., similar demographics, etc. to the target user) to the recommendation server 102. Further, in some implementations, when certain pieces of profile information (e.g., one or more missing columns, such as the top 10 items most highly rated by the user) are missing for these target users, the supervised learning module 234a treats the missing profile information as missing values in the predictive model. The supervised learning module 234a may also determine whether there is a need to simulate the case of incomplete profile information for all users. For example, when very little information is available about the users and this information can be imputed through simulation or otherwise, in response to which the supervised learning module 234a excludes that specific piece of profile information for all users in the dataset and builds a new model based on this restricted data.

In some implementations, such as in the case of new target users with only minimal information (e.g., with only an IP address, geo-location, or device type, etc.), the supervised learning module 234a creates models based on the existing dataset by excluding both history (e.g., server logged data, as describe elsewhere herein) and profile information for a set of users from the dataset in order to make them appear to be new users with only minimal information to the recommendation server 102. For example, the history and profile information can be dropped from the users in this dataset except for that data known about the users (e.g., IP-based features such as geo-location) and the supervised learning module 234a retrains the model based on this restricted data. In the same way that user data can be excluded, it is also possible to exclude portions (e.g., individual columns) of the dataset, such as watch history, likes, shares, etc. of items in the dataset in order to mimic the case of new items and build models trained on the reduced dataset.

In some implementations, the supervised learning module 234a creates multiple models for each supervised learning method and/or on different subsets of original or overall dataset (e.g. different subsets of user data, subsets of item data or subsets of interaction data). In some implementations, multiple models can be created and their results can be combined using simple averaging, weighted averaging, or stacking. In the case of combining multiple models, the supervised learning module 234a may use a stacking-based tuning approach or a simple averaging, which does not involve tuning. In some implementations, the supervised learning module 234a optimizes a quantity of gradient boosted models to be combined by, for example, generating different numbers of datasets from the original dataset as described above, combining the models created for each dataset, and comparing the accuracies obtained for the different numbers of models.

In some implementations, the supervised learning module 234a selects and trains multiple models (e.g., separate gradient boosted models) on each sample dataset or subset dataset and then combines the models by a simple averaging approach, which would allow each model to be an expert on a different subset dataset that is restricted in the overall dataset or master dataset. In some implementations, multiple models can be created on the dataset and combined using a stacking approach. For instance, the supervised learning module 234a first creates a support vector machine, a gradient boosted model, and a linear model, and then creates a final model that takes the predictions of each these models as inputs together with the original inputs and the final model predicts the outputs.

In some implementations, the supervised learning module 234a evaluates the model(s) using the test set. In some implementations, the supervised learning module 234a evaluates models on the existing dataset by mimicking the production environment by holding out groups of one or more of users, items, and user-item interactions from the training dataset and measuring the degree to which these excluded interactions were predicted by the model. For example, specific accuracy criteria may include the precision @ k (e.g., the number of relevant results on the first search results page), hit rate, and/or other engagement metrics where each user interaction can be assigned to a concrete business value, such as profit, advertising revenue, etc. In some implementations, the supervised learning module 234a updates the models based on test accuracy, online learning or active learning approaches.

In some implementations, after a model has been trained, the model generation module 232 performs additional featurization in the modeling loop in order to increase accuracy of the model. There are several approaches by which this additional featurization may be performed, such as eliminating or adding features through stepwise regression (e.g., forward selection and backward elimination) or generating additional features utilizing model predictions, such as item-based collaborative filtering, as described elsewhere herein.

The recommendation module 236 includes computer logic executable by the processor 202 to generate recommendations using the supervised learning model received from the model generation module 232. In some implementations, the recommendation module 236 receives as input the number of recommendations that is to be presented to a target user and the model created by model generation module 232. Given any particular user, the recommendation module 236 creates a corresponding user-test dataset which consists of the features for a list of user-item pairs, where the user is the particular user under consideration, and the items consist of either the full set of available items, or a subset of candidate items that is selected according to a criterion specified. The selection procedure for the subset of candidate items can be done by a combination of the following methods, but is not restricted to these methods: (1) Selecting the most popular k items where k is some positive integer, e.g., 10,000, and popularity is measured in terms of the number of overall positive interactions such as purchases or likes, or the current rate of positive interactions. (2) Selecting candidate items from the recommendations provided by another, possibly simpler recommendation system, for example, from the collaborative filtering module 228 and the popularity based modelling module 230. Once the set of candidate items are chosen for a user (and this set may well be the set of all available items), the recommendation module 236 combines the item features for this set of items together with the user features, to create the aforementioned user-test set. It then produces prediction scores for a user-item interaction or user response using the model and then ranks the item based on these scores (e.g. with the highest predicted score obtaining the top rank). This ordered rank list is then truncated based on the input received by the recommendation module 236. The aforementioned scores can be estimated probabilities that a user will like or purchase an item, or, in cases where the model facilitates prediction of interaction durations (e.g., the length of time a user will watch a video), the ranking is based on the predicted duration of interaction (with e.g., the highest predicted watch length obtaining the top rank). This “prediction” can then be replicated as many times as is necessary for the required service level agreements (SLAs).

In some implementations, the recommendation module 236 creates a candidate set of items and predictions of user responses. In some implementations, the recommendation module 236 determines whether the total set of available items for which predictions are to be calculated is too large (e.g., large enough that it is unfeasible to calculate predicted responses for each item) and, in response, use a reduced set of candidate items. If the set of items is not large, the recommendation module 236 may not use a candidate set of items, but may calculate recommendations using the model based on the complete set.

In some implementations, the recommendation module 236 may first create a candidate set of items for a target user (new or existing user) and then make predictions for the response of the target user for each candidate item. Various approaches can be used to select a candidate set of items for each user. For example, in one approach, the recommendation module 236 selects a candidate set of a given number (e.g., 1000) of the most popular items (e.g., in a category or all categories) for a new user (with no profile information and/or history of interaction data). In another example approach, the recommendation module 236 constructs a list of item categories or tags that the target user is most engaged or interacted favorably with (e.g., in terms of ratings, views, etc.) and selects a number (e.g., 100) of the most popular items from each category or tag. If the target user is a new user (e.g., some profile information but no history of interaction data), the second approach may include the recommendation module 236 using the top categories of items interacted with favorably by other users with similar demographics as the target user, which was determined using the information that is available about the target user.

In another example approach, the recommendation module 236 obtains various notions of similarity from the collaborative filtering module 228 and the popularity based modelling module 230 and selects a candidate set of items by generating a list of a given number of items (e.g., 1000) that are most similar to the top (e.g., top rated, viewed, purchased, etc.) items by that target user or other users similar to the target user in terms of demographics, profile information, etc. Various notions of similarity include rating-based similarities, as in collaborative filtering, or item feature based similarities, such as the L2 distance between a vector representations of item features. If no items have been rated or viewed by the target user (e.g., as in a new user or cold start), this approach may include the recommendation module 236 creating a candidate set of items for users most similar to the current user in terms of available information or demographics.

In another example approach, the recommendation module 236 uses business rules to select a candidate set of items for a user. The candidate set of items may not necessarily be selected from all available items. The business rules can dictate what type of items may be added to the candidate set of items. For example, the business rules may influence the recommendation system to give a higher weight to certain products. A business might do this for various reasons like contractual or vested interest, such as Netflix™ (or other on-demand Internet streaming media or flat rate DVD by mail or other subscription service) may want to increase the likelihood of marketing or recommending their own content, and Amazon™ (or other on-line retailer) may do the same for their own Amazon™ Basics line of products.

In some implementations, the recommendation module 236 selects items with the most favorable predicted user response for presentation to the user, such as items with the longest predicted user interaction times. The recommendation module 236 creates the recommendations by applying the features of each item (in the candidate or total set, as described above) to the created model(s) for the current target user, thereby calculating a predicted response by the user to each item. The recommendation module 236 may order the items that are predicted to result in the most favorable response by the user and present those items to the user in the best predicted order. The most favorable response may be defined by a user response such as interaction time, likelihood to view, purchase, profit per purchase, or share the item, and so forth.

In some implementations, the recommendation module 236 applies additionally or alternatively the business rules and business objectives described above (or different business requirements or rules) when selecting recommendations by further filtering, sorting, and/or ordering the candidate set of items and/or the selected set of items. For example, a business requirement or rule may dictate that a first weight be assigned to items based on profitability of an item from advertising revenue (because of contractual or vested interest) while a second weight be assigned to items based on duration of user interaction times. In another example, the business requirements or rules may dictate that a particular quantity or type of item be presented among the first items presented to a user, e.g., 2 out of the first 5 of the products may be made by a particular manufacturer, have a particular price, or have other characteristics relevant to business requirements programmed into the system. In another example, the proxy value which is chosen to maximize the business objective as described above may determine the ordering of recommendations for presentation to the user.

In some implementations, the recommendation module 236 may augment the model(s) with a popularity-based naïve model from the popularity-based modeling module 230. In some implementations, the recommendation module 236 uses the popularity-based naïve model to generate recommendations. The recommendation module 236 may switch from a popularity-based naïve model to a predictive model based on an objective function or decision criterion such as the confidence in the predictions of the predictive model. For example, the recommendation module 236 uses the model instead of baseline popularity-based naïve model when model prediction has high confidence, etc.

In some implementations, the recommendation module 236 may implement active learning algorithms, for example, by presenting specially selected items to the user with the purpose of eliciting user feedback, whether negative (e.g., skipping, ignoring, rejecting, disapproving etc.) or positive (e.g., liking, sharing, purchasing, viewing, viewing in the entirety, etc.), which would maximize the information gained by the recommendation unit 104 about the users' preferences with as little user interaction as possible. In some implementations, the recommendation module 236 performs this process for new users or items for which there is not sufficient information to make good recommendations with high confidence, so that the recommendation module 236 (and/or recommendation unit 104) may determine user preferences for the new user quickly. In some implementations, the recommendation module 236 performs this process for existing users, where confidence in the existing user's preferences is low or the confidence in specific or current recommendations is low, such as if the user starts to interact with an item (e.g., browse a particular website, view different types of videos, etc.) for which there is either little information about the user or item or the user-item interactions. For example, an existing user may have never watched a certain genre of movie before, so the recommendation module 236 may show items which would help it understand the user preferences as quickly as possible, even though the recommendations themselves are not tuned for maximizing the objective (e.g., longest interaction time, a business objective or requirement, etc.).

The update module 238 includes computer logic executable by the processor 202 to frequently take new data and update the models created by the model generation module 232 based on the new data. In some implementations, the update module 238 may access the model(s) and/or data stored in the storage device 212 to determine whether a model needs to be updated. For example, the update module 238 may determine that new data, such as a new user-item interaction, has been received and a model should be recalculated or retrained based on the new data.

In some implementations, the update module 238 updates the models with new data. For example, after the recommendation module 236 presents the selected items with the most favorable predicted response to the target user, the user will take some action, whether negative (skipping, ignoring, rejecting, disapproving, etc.) or positive (liking, sharing, purchasing, viewing, viewing in the entirety, etc.). The update module 238 may take this new interaction data and feed it back into the dataset thereby making the dataset, and by consequence, the model trained on the dataset, more accurate. For example, the update module 238 updates the model immediately using online learning algorithms. In other words, every user interaction with the output of the system (i.e., recommendation unit 104) may be fed back into the system to update the model immediately before the next set of recommendations are made. This requires special algorithms to ensure an interactive user experience, where the recommendations are kept fresh based on frequent model updates due to new interaction data. In another scheme, the update module 238 uses the user feedback to update the system after a batch of feedback is collected. The update module 238 may also automatically choose which scheme to apply and whether to apply a combination scheme, adjusting as needed to satisfy constraints while optimizing for the business objective, such as profit. In some implementations, the update module 238 may update the model(s) (or cause them to be updated or recreated by the supervised learning module 234a) when additional user, item, or user-item interaction data becomes available.

### Example Methods

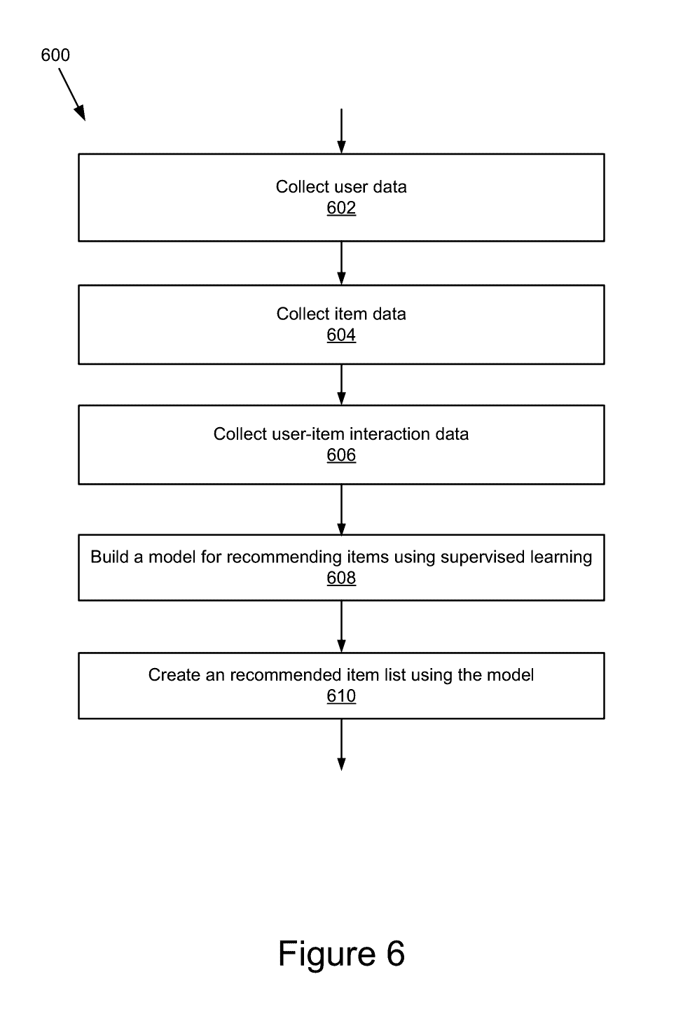

FIG. 6 is a flowchart of an example method 600 for creating a recommendation system and using it to determine a recommended item list in accordance with one implementation of the present disclosure. At block 602, the data collection module 220 collects user data for one or more users. The data collection module 220 may obtain the user data from the one or more of the item server 108 or from the data collector 110. In some implementations, the recommendation unit 104 provides user data to the data collection module 220 in response to receiving a request to determine recommendations for the user (e.g., after the recommendation unit 104 determines the recommendations for the user).

At block 604, the data collection module 220 collects item data for one or more items, which may occur in the same or similar way to or along with the collection of user data discussed above. The data collection module 220 and/or the data preparation module 226 may augment or featurize the item data to describe items or similarity between items, as described elsewhere herein.

At block 606, the data collection module 220 collects user-item interaction data for one or more users and items, which may occur in a similar way to or along with the collection of user data and/or item data discussed above. In some implementations, the storage device 212 may already contain user data and item data, but the data collection module 220 updates the interaction data to include an interaction of the user with the item (e.g., as received, or, in some instances, as the interaction occurs).

At block 608, the model generation module 232 builds a model for recommending items using supervised learning. At 610, the recommendation module 236 creates a recommended item list using the model created at 610. In some implementations, the recommendation module 236 may use one or more models based one or more portions of the dataset to predict the user response for all items, the items in a category, or a reduced set of candidate items.

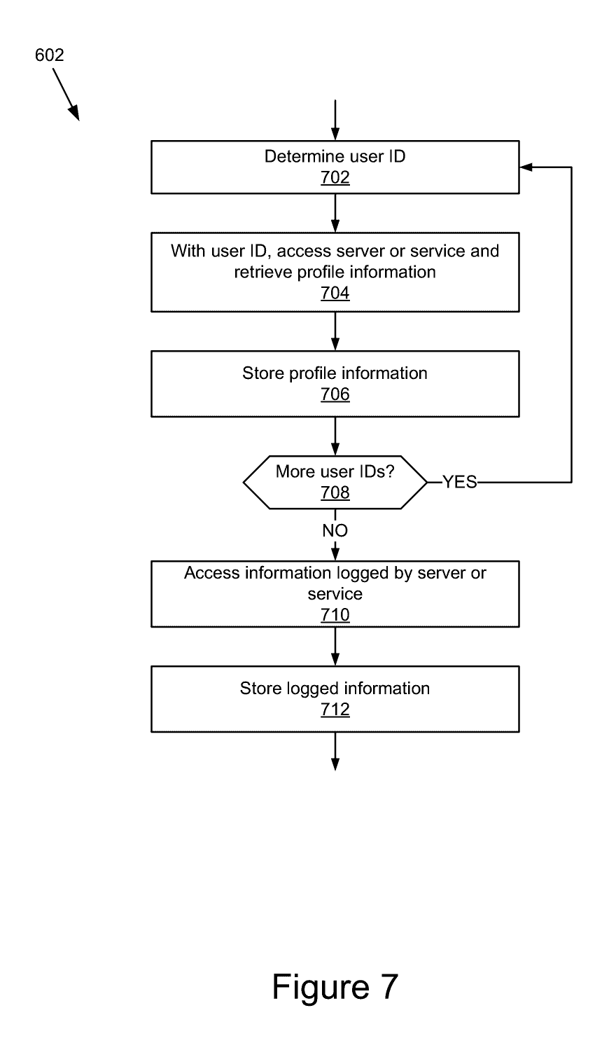

FIG. 7 is a flowchart of an example method 602 for collecting user data in accordance with one implementation of the present disclosure. The user data (examples of which are displayed in FIG. 3) may be collected using user profile information for users (e.g., those registered to the recommendation server 102 or a server accessible by the recommendation server 102) and/or information logged by a server (e.g., one or more of the item server 108 or data collector 110 as depicted in FIG. 1). At block 702, the data collection module 220 determines a user ID for a user for whom it is obtaining or updating data. At block 704, the data collection module 220 uses the user ID to access a server or service and obtain profile information (e.g., age, education, profession, geographic location, interests, etc.). At block 706, the data collection module 220 stores the profile information in a storage device 212. At block 708, the data collection module 220 determines whether there are additional user IDs for which it should obtain profile information. At block 710, the data collection module 220 accesses information logged by a server or service regarding each user, as available. For example, information logged by a server or service may include the IP address of the client device 114, the browser type used by the user, the operating system of the client device 114, information registered or tracked by browser cookies reflecting past visits from the same user, etc. At block 712, the data collection module 220 stores the logged information in a storage device 212.

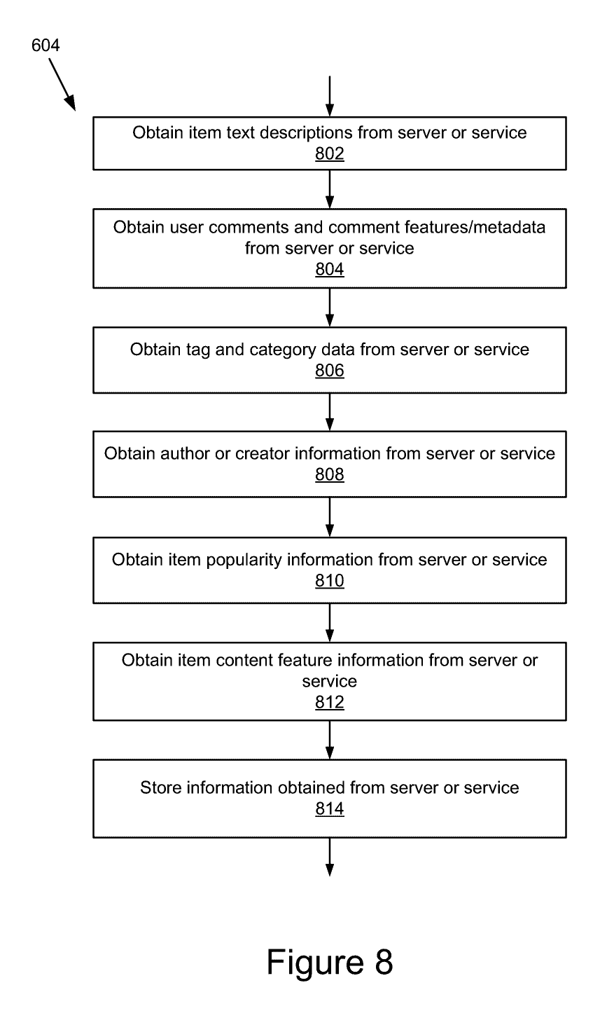

FIG. 8 is a flowchart of an example method 604 for collecting item data (examples of which are displayed in FIG. 4) in accordance with one implementation of the present disclosure. At block 802, the data collection module 220 obtains item text descriptions from a server or service. For example, the item description text on a service may include a description of a video, book, product, etc., as well as features generated from the text, such as vector space representations of the text. At block 804, the data collection module 220 obtains user comments, such as comments on an item, and comment features (e.g., metadata) from a server or service. For example, comment features may include features generated from the comments, such as the number of comments, vector space representations of text comments, sentiment features generated from comments using natural language processing, etc. At block 806, the data collection module 220 obtains tag and/or category data from a server or service. For example, a tag and category may reflect the genre of an item and may be chosen for an item by users of a server or service or by experts regarding the item.

At block 808, the data collection module 220 obtains author or creator information from a server or service. At block 810, the data collection module 220 obtains item popularity information from a server or service. For example, item popularity information may include view count, number of likes, dislikes, or purchases, popularity history (historical number of likes, dislikes, purchases, views, or a current rate of change thereof), etc. At block 812, the data collection module 220 obtains item content feature information from a server or service. For example, item content features may include the length of a video or song, melodic or rhythmic features of a song extracted automatically or input by an expert, color features of a video, the topic of an article extracted via topic modeling, etc. At block 814, the data collection module 220 stores the information obtained from the server or service in the storage device 212.

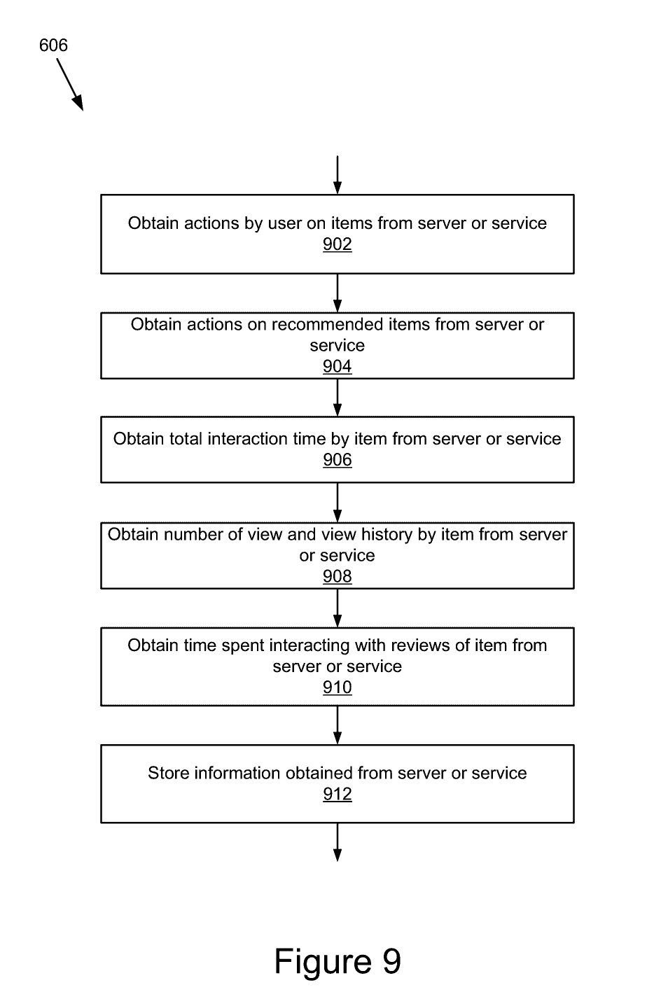

FIG. 9 is a flowchart of an example method 606 for collecting user-item interaction data (examples of which are displayed in FIG. 5) in accordance with one implementation of the present disclosure. At block 902, the data collection module 220 obtains actions (e.g., likes, dislikes, purchases, skips, views, length of views, etc.) by one or more users on items from a server or service. At block 904 the data collection module 220 obtains actions on items which are recommended to the user by a server or service. At block 906, the data collection module 220 obtains the total interaction time or duration by a user with each item from a server or service. At block 908, the data collection module 220 obtains the number of views of an item by a user and/or a detailed view history (e.g., how many times and when the user viewed the item). At block 910, the data collection module 220 obtains the time spent by the user interacting with (e.g., reading) reviews of an item from a server or service. At block 912, the data collection module 220 stores the user-item interaction information in the storage device 212 (e.g., in a table or series of rows, as described elsewhere herein).

It should be understood that while FIGS. 7-9 include a number of steps in a predefined order by way of example, the methods need not necessarily perform all of the steps or perform the steps in the same order. The methods may be performed with any combination of the steps (including fewer or additional steps) different than that shown in FIGS. 7-9. The methods may perform such combinations of steps in a different order.

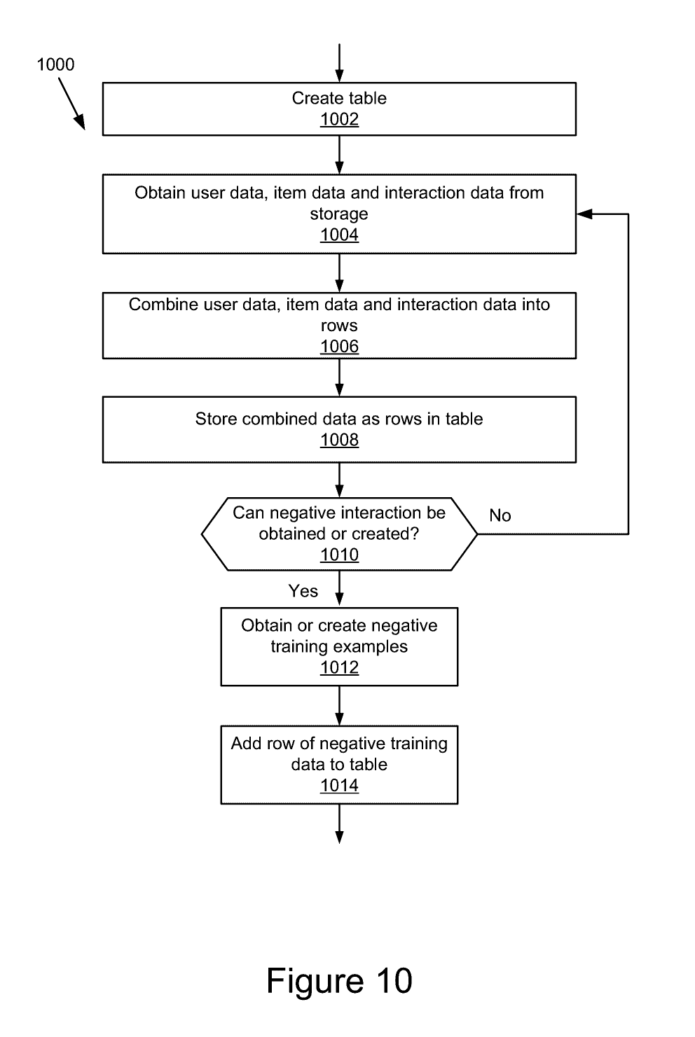

FIG. 10 is a flowchart of an example method 1000 for aggregating, organizing, and augmenting user, item, and interaction data in accordance with one implementation of the present disclosure. At block 1002, the data preparation module 226 creates a table in which to organize the user, item, and interaction data. At block 1004, the data preparation module 226 obtains user data, item data, and interaction data from storage. At block 1006, the data preparation module 226 combines the user data, item data, and interaction data into rows that will be used for training a model using, for example, the supervised learning module 234 and at block 1008, the data preparation module 226 stores the combined data into rows in the table.

At block 1010, the data preparation module 226 determines whether one or more negative interaction data can be obtained or created. The data preparation module 226 may make the determination based on one or more factors such as whether there is a prior rating system (e.g., a like, dislike, etc.) that is in place for the users or items, whether there was a recommendation system in place, if there is available information about item popularity, views, presentations to users, etc. For example, the data preparation module 226 may determine whether there were prior recommendations of items made to the user and whether the user rejected, skipped, or ignored the recommended items.

If negative interactions can be obtained or created, at block 1012, the data preparation module 226 obtains or creates negative training examples and at 1014, the data preparation module 226 adds rows for the negative training examples to the data in the table. In some implementations, negative examples may already be stored in a storage device 212 or on a server or service, such as 108 or 110 to be obtained by the data preparation module 226. If negative interactions cannot be obtained or created, the method 1000 repeats the process at step 1004.

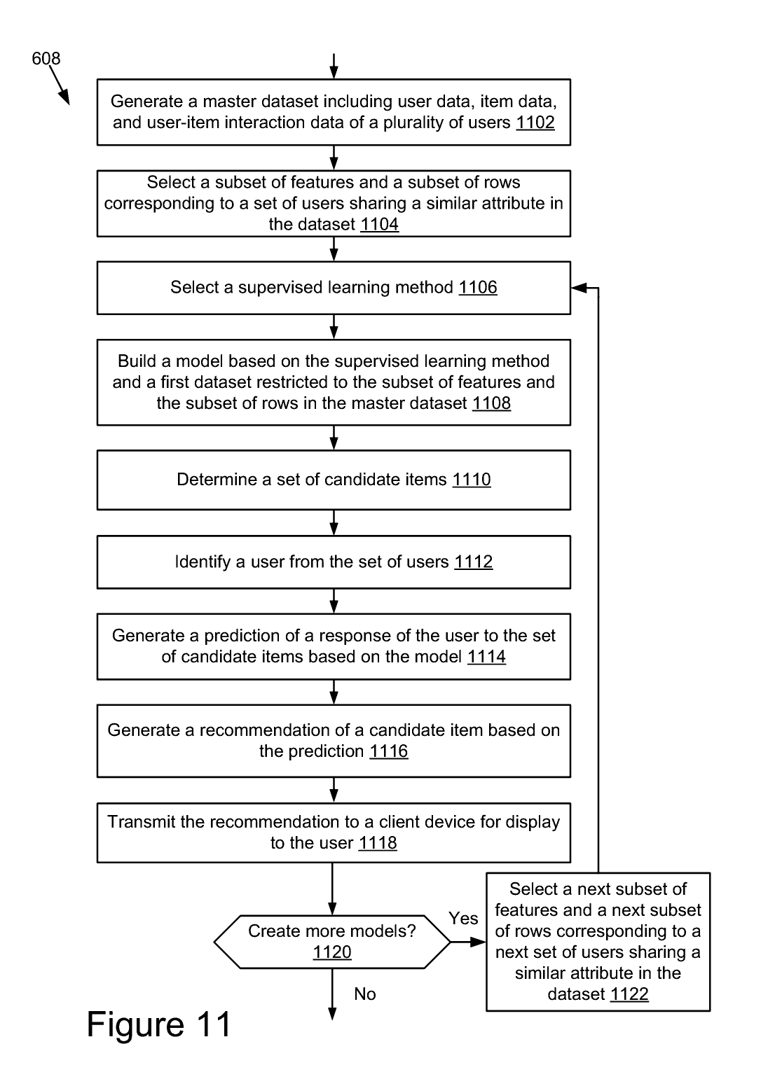

FIG. 11 is a flowchart of an example method 608 for building a model for recommending items using supervised learning in accordance with one implementation of the present disclosure. At block 1102, the data preparation module 226 generates a master dataset including user data, item data, and user-item interaction data of a plurality of users. At block 1104, the supervised learning module 234 selects a subset of features and a subset of rows corresponding to a set of users sharing a similar attribute in the dataset. At block 1106, the supervised learning module 234 selects a supervised learning method. At block 1108, the supervised learning module 234 builds a model based on the supervised learning method and a first dataset restricted to the subset of features and the subset of rows in the master dataset.

At block 1110, the recommendation module 236 determines a set of candidate items. At block 1112, the recommendation module 236 identifies a user from the set of users. At block 1114, the recommendation module 236 generates a prediction of a response of the user to the set of candidate items based on the model. At block 1116, the recommendation module 236 generates a recommendation of a candidate item based on the prediction. At block 1118, the recommendation module 236 transmits the recommendation to a client device for display to the user.

At block 1120, the supervised learning module 234 determines whether more models can be created. If more models can be created, at block 1122, the supervised learning module 234 selects a next subset of features and a next subset of rows corresponding to a next set of users sharing a similar attribute in the dataset. If more models cannot be created, the method 608 stops the process.

The foregoing description of the implementations of the present disclosure has been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As should be understood by those familiar with the art, the present disclosure may be embodied in other specific forms without departing from the spirit or essential characteristics thereof. Likewise, the particular naming and division of the modules, routines, features, attributes, methodologies and other aspects are not mandatory or significant, and the mechanisms that implement the present disclosure or its features may have different names, divisions and/or formats. Furthermore, as should be apparent to one of ordinary skill in the relevant art, the modules, routines, features, attributes, methodologies and other aspects of the present disclosure may be implemented as software, hardware, firmware or any combination of the three. Also, wherever a component, an example of which is a module, of the present disclosure is implemented as software, the component may be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present disclosure is in no way limited to implementation in any specific programming language, or for any specific operating system or environment. Accordingly, the disclosure of the present disclosure is intended to be illustrative, but not limiting, of the scope of the present disclosure, which is set forth in the following claims.

What is claimed is:

1. A computer-implemented method comprising:
generating, using one or more computing devices, a master dataset including user data, item data, and user-item interaction data of a plurality of users;
selecting, using the one or more computing devices, a subset of features and a subset of rows in the master dataset, the subset of rows corresponding to a first set of users sharing a similar attribute in the master dataset;
selecting, using the one or more computing devices, a supervised learning method;
building, using the one or more computing devices, a first model based on a first dataset and the supervised learning method, the first dataset being restricted to the subset of features and the subset of rows in the master dataset;
identifying, using the one or more computing devices, a first user from the first set of users;
determining, using the one or more computing devices, a set of candidate items;
generating, using the one or more computing devices, a prediction of a user response of the first user to the set of candidate items based on the first model;
generating, using the one or more computing devices, a recommendation of a first candidate item based on the prediction; and
transmitting, using the one or more computing devices, the recommendation to a client device for display to the first user.

2. The computer-implemented method of claim 1, wherein generating the dataset comprises:
retrieving user data of the plurality of users;
retrieving item data of a plurality of items;
retrieving positive user-item interaction data for the plurality of users and the plurality of items;
determining whether negative user-item interaction data for the plurality of users and the plurality of items is retrievable;
responsive to determining that the negative user-item interaction data is non-retrievable, artificially creating the negative user-item interaction data; and
combining the user data, the item data, the positive user-item interaction data, and the negative user-item interaction data into a plurality of rows in the dataset.

3. The computer-implemented method of claim 2, where artificially creating the negative user-item interaction data comprises:
identifying a set of active users in the dataset;
identifying a set of topmost active items that the set of active users ignored; and
artificially creating the negative user-item interaction data based on the set of active users and the set of topmost active items.

4. The computer-implemented method of claim 1, wherein determining the set of candidate items comprises:
determining a business rule influencing the recommendation of the first candidate item; and
determining the set of candidate items that satisfies a constraint of the business rule.

5. The computer-implemented method of claim 4, further comprising:
determining whether the first user is a new user;
responsive to determining that the first user is the new user, identifying a number of items for inclusion in the set of candidate items that satisfies the constraint of the business rule, the number of items identified from one or more of items most popular with existing users, and items interacted with favorably by a set of one or more other users similar to the first user.

6. The computer-implemented method of claim 4, further comprising:
determining whether the first user is a new user;
responsive to determining that the first user is not the new user, identifying a number of items for inclusion in the set of candidate items that satisfies the constraint of the business rule, the number of items identified from one or more of items most popular with existing users, items similar to those items interacted with favorably by the first user, and items interacted with favorably by a set of one or more other users similar to the first user.

7. The computer-implemented method of claim 1, further comprising:
determining a business objective;
determining a business rule influencing the recommendation of the first candidate item; and
identifying a proxy for the business objective, the proxy for the business objective being based on the prediction of the user response, wherein the recommendation of the first candidate item is based on an optimization of the proxy for the business objective and a constraint of the business rule.

8. The computer-implemented method of claim 1, wherein the similar attribute includes one from a group of usage behavior and demographics.

9. The computer-implemented method of claim 4, wherein the business objective includes one from a group of profit, revenue, user retention, number of user interactions, user interaction time, and user interaction type.

10. The computer-implemented method of claim 1, wherein the user response of the first user to the set of candidate items includes one from a group of like, dislike, purchase, view, ignore, rating, money spent, profit resulting from purchase and total interaction time.

11. A system comprising:
one or more processors; and
a memory including instructions that, when executed by the one or more processors, cause the system to:
generate a master dataset including user data, item data, and user-item interaction data of a plurality of users;
select a subset of features and a subset of rows in the master dataset, the subset of rows corresponding to a first set of users sharing a similar attribute in the master dataset;
select a supervised learning method;
build a first model based on a first dataset and the supervised learning method, the first dataset being restricted to the subset of features and the subset of rows in the master dataset;
identify a first user from the first set of users;
determine a set of candidate items;
generate a prediction of a user response of the first user to the set of candidate items based on the first model;
generate a recommendation of a first candidate item based on the prediction; and
transmit the recommendation to a client device for display to the first user.

12. The system of claim 11, wherein the instructions to determine the set of candidate items, when executed by the one or more processors, cause the system to:
determine a business rule influencing the recommendation of the first candidate item; and
determine the set of candidate items that satisfies a constraint of the business rule.

13. The system of claim 12, wherein the instructions, when executed by the one or more processors, further cause the system to:
determine whether the first user is a new user;
responsive to determining that the first user is the new user, identify a number of items for inclusion in the set of candidate items that satisfies the constraint of the business rule, the number of items identified from one or more of items most popular with existing users, and items interacted with favorably by a set of one or more other users similar to the first user.

14. The system of claim 12, wherein the instructions, when executed by the one or more processors, further cause the system to:
determine whether the first user is a new user;
responsive to determining that the first user is not the new user, identify a number of items for inclusion in the set of candidate items that satisfies the constraint of the business rule, the number of items identified from one or more of items most popular with existing users, items similar to those items interacted with favorably by the first user, and items interacted with favorably by a set of one or more other users similar to the first user.

15. The system of claim 11, wherein the instructions, when executed by the one or more processors, further cause the system to:
determine a business objective;
determine a business rule influencing the recommendation of the first candidate item; and
identify a proxy for the business objective, the proxy for the business objective being based on the prediction of the user response, wherein the recommendation of the first candidate item is based on an optimization of the proxy for the business objective and a constraint of the business rule.

16. A computer-program product comprising a non-transitory computer usable medium including a computer readable program, wherein the computer readable program, when executed on a computer, causes the computer to perform operations comprising:
generating a master dataset including user data, item data, and user-item interaction data of a plurality of users;
selecting a subset of features and a subset of rows in the master dataset, the subset of rows corresponding to a first set of users sharing a similar attribute in the master dataset;
selecting a supervised learning method;
building a first model based on a first dataset and the supervised learning method, the first dataset being restricted to the subset of features and the subset of rows in the master dataset;
identifying a first user from the first set of users;
determining a set of candidate items;
generating a prediction of a user response of the first user to the set of candidate items based on the first model;
generating a recommendation of a first candidate item based on the prediction; and
transmitting the recommendation to a client device for display to the first user.

17. The computer program product of claim 16, wherein the operations for determining the set of candidate items further comprise:
determining a business rule influencing the recommendation of the first candidate item; and
determining the set of candidate items that satisfies a constraint of the business rule.

18. The computer program product of claim 17, wherein the operations further comprise:
determining whether the first user is a new user; and
responsive to determining that the first user is the new user, identifying a number of items for inclusion in the set of candidate items that satisfies the constraint of the business rule, the number of items identified from one or more of items most popular with existing users, and items interacted with favorably by a set of one or more other users similar to the first user.

19. The computer program product of claim 17, wherein the operations further comprise:
determining whether the first user is a new user;
responsive to determining that the first user is not the new user, identifying a number of items for inclusion in the set of candidate items that satisfies the constraint of the business rule, the number of items identified from one or more of items most popular with existing users, items similar to those items interacted with favorably by the first user, and items interacted with favorably by a set of one or more other users similar to the first user.

20. The computer program product of claim 16, wherein the operations further comprise:
determining a business objective;
determining a business rule influencing the recommendation of the first candidate item; and
identifying a proxy for the business objective, the proxy for the business objective being based on the prediction of the user response, wherein the recommendation of the first candidate item is based on an optimization of the proxy for the business objective and a constraint of the business rule.
